(19) United States
(12) Patent Application Publication
(10) Pub. No.: US 2007/0011290 A1
(43) Pub. Date: Jan. 11, 2007

(54) Method and system for facilitating the advertising of an animal

(76) Inventor: R. Scott Schaedle, Atlanta, GA (US)

Correspondence Address: PETER L. BREWER BEARMAN, CALDWELL, & BERKOWITZ;LAW FIRM, 165 MADISON AVENUE, SUITE 2000, MEMPHIS, TN, 38103, US

(21) Appl. No.: 11/174,952

(22) Filed: Jul. 5, 2005

(51) Int. Cl. G06F 15/173

(52) U.S. Cl. 709/223

(57) ABSTRACT

A method and system for facilitating the advertising of animals is provided. Textual and graphics information is received from a plurality of prospective sellers as to their animals. This graphic information includes video footage of the animals. Selected information is place onto a website that allows prospective purchasers to search for animals having certain characteristics, and to then order video clips for selected animals. The animals may include show horses, and videos for the selected horses may be ordered on-line. The prospective purchasers and sellers may then communicate offline.

### BACKGROUND OF THE INVENTION

1. Field of the Invention

The present invention relates to the advertising of animals. More specifically, the invention relates to a web-based method for facilitating the sale or breeding of animals such as horses.

2. Description of the Related Art

It has been known for many years to provide a sale barn for the sale of livestock. Many cities and counties have their own livestock barns where sales, oftentimes in the form of auctions, take place. Such sales events may be held on a monthly or even a weekly basis. Such periodic sales events may include any kind of livestock such as horses, hogs and goats. Sales barns provide a ready location for the sale and purchase of livestock. However, such local sales events generally price livestock as commodities, and generally require that the purchaser be present to learn about the animals that are for sale.

In some instances, livestock may have a greater intrinsic value. This is particularly true in the case of racing horses, show horses and walking horses. This is also true for other show animals such as dogs. However, it generally remains necessary or at least very desirable for a prospective purchaser to travel to the site where the animal is kept in order to inspect the animals before deciding to make an offer for the animal.

In some instances, an animal may be placed for sale by a private ranch or breeding farm. In other instances, a breeding farm may advertise for the breeding of a stallion. Yet even in these instances, it is oftentimes necessary for the prospective purchaser to travel to the location to obtain his or her first look at the animal for sale or breeding.

With the advent of the internet, some sellers have placed livestock for sale through on-line auction sites. Such sites include ebay.com at http://buy.ebay.com/horse. Other sites are considered listing sites, and present photographs of horses for sale. Such sites include www.thehorsesource.com. However, a mere still photograph does not permit a prospective purchaser or breeder to make an adequate initial investigation of the animal to determine whether it is worth the time and money to travel to the place where the animal resides. This is particularly true in the case of an expensive horse whose value is rooted in its ability to walk in a distinctive manner, to run at great speeds or to serve as a show horse.

Therefore, a need exists for a system by which prospective sellers of animals can list their respective animals for sale. A need further exists for a centralized network by which information about the animals, including video clips, can be obtained by prospective sellers or breeders. Further, a need exists for a web-based method for facilitating the sale or breeding of show animals such as horses whereby video clips of multiple horses may be obtained from prospective sellers, and then selected by prospective purchasers for review prior to further inquiry. In this manner, prospective purchasers need not travel to see animals that do not fit the purchaser's needs, standards or tastes.

### SUMMARY OF THE INVENTION

A method for facilitating the advertising of animals is provided. In one embodiment, the method includes the steps of receiving textual information from a plurality of prospective sellers as to respective animals; placing the information from the plurality of prospective sellers onto a database; obtaining a video clip for each of the respective animals so as to provide a library of corresponding video clips; making the textual information available for searching through a web-based platform; receiving orders from prospective purchasers for video clips of one or more selected animals; downloading at least a portion of the requested one or more video clips onto a digital video disc; and delivering the digital video disc to the prospective purchaser.

It is preferred that the animals are show animals such as show horses or show dogs. However, any animal may be advertised through the method.

The server operator may obtain video clips in any format, including analog tapes. In this instance, the server operator would convert the analog video tapes to digital files for saving onto the database. In one aspect, the server operator itself creates digital video files of horses and then loads those files onto the database.

In one embodiment, the database is part of a server having software for operating a website. The website is operated by a server operator. The server operator may place at least a portion of the obtained video clips on the website for viewing on-line. It is also preferred that the step of receiving orders from prospective purchasers for video clips be done electronically through the website.

When a request is received from a prospective purchaser, the server operator will create the digital video disc, or DVD, by burning selected video and, optionally, photographs, onto the DVD. The server operator may optionally place a promotional file for its business onto the DVD. The website operator may also index the video for multiple horses on the DVD. A promotional file for an advertiser may also be burned onto the DVD. When the DVD is ready, it is mailed or otherwise delivered to a prospective purchaser.

A system for facilitating the advertising of animals is also provided. In one embodiment, the system includes a user interface for a server operator; a network interface comprising a web browser and a data link; and a server defining a web-based platform having a processor, memory and software for enabling the server operator to communicate with a plurality of users through a global data network such as the worldwide web. The platform enables the server operator to receive textual information from a plurality of prospective sellers as to respective animals, place the information from the plurality of prospective sellers onto a data network, make the data network available for searching through a web-based platform, and receive orders from prospective purchasers for video clips of one or more selected animals. The video clips have been previously obtained from the plurality of prospective sellers.

The user interface for the server operator is preferably a desktop or laptop computer. The memory includes a database for receiving textual and graphics information from the prospective sellers of the animals. The network interface may further comprise an internet server operator.

It is preferred that the web-based platform is a website that permits users using the worldwide web to enter data about animals that are for sale. The website allows prospective sellers to create listings for their animals, and allows prospective purchasers to search the animals that have been listed and then review data about the individual animals found.

Preferably, the animals are show horses.

### BRIEF DESCRIPTION OF THE DRAWINGS

So that the manner in which the above recited features of the present invention can be better understood, certain drawings, flow charts or screenshots are appended hereto. It is to be noted, however, that the appended figures illustrate only selected embodiments of the inventions and are therefore not to be considered limiting of scope, for the inventions may admit to other equally effective embodiments and applications. For example, the screenshots represent specific expressions of web pages. However, the invention is not limited to these specific expressions.

FIG. 1 presents a system for facilitating the sale of animals, in one embodiment.

FIG. 2 is a flowchart showing steps for using the system of FIG. 1. Such steps include the listing of an animal for sale by a prospective seller, and the ordering of video information through the system by a prospective purchaser

FIG. 3A is an illustrative screenshot for a home page for the website of the system of FIG. 1.

FIG. 3B is an exemplary screenshot for an instructions page for prospective sellers as might be used in the present system.

FIG. 3C is a screenshot for a log-in page for prospective sellers using the website of the present system.

FIGS. 3D is a screenshot for a registration page for the website, in one arrangement.

FIG. 4A is a screenshot providing information for prospective sellers of animals for the system of FIG. 1.

FIG. 4B is another screenshot providing information for prospective sellers of animals and other users of the system of FIG. 1.

FIG. 4C is yet another screenshot providing information for prospective sellers of animals.

FIGS. 4D-4G provide sequential illustrative screenshots for listing an animal for sale or breeding using the system of FIG. 1.

FIG. 4H is an illustrative screenshot for a form by which a prospective seller may provide additional information to the server operator of the system of FIG. 1.

FIG. 4I is a representative screenshot showing animals that have been listed on the website by a prospective seller.

FIG. 4J is a screenshot for use by a prospective seller for renewing a previous listing of an animal on the website of the system of FIG. 1.

FIG. 5A is an illustrative screenshot for a prospective purchaser to search for an animal.

FIG. 5B demonstrates a subsequent screenshot allowing the prospective purchaser to search for a breeding animal.

FIG. 5C demonstrates a subsequent screenshot allowing the prospective purchaser to search for an animal that is for sale.

FIG. 5D is a screenshot showing search results from use of the screenshot of FIG. 5B.

FIG. 5E is a screenshot showing search results from use of the screenshot of FIG. 5C.

FIG. 5F is a screenshot showing a search result for animals available for lease.

FIG. 5G presents an illustrative screenshot showing a search result for all animal listings.

FIGS. 5H and 5I present illustrative screenshots showing the profile of an individual animal. In FIG. 5H photos of the animal are shown, while in FIG. 5I a short video clip is provided.

FIG. 5J is a screenshot showing animals selected by a prospective purchaser for a DVD order.

FIG. 5K is a screenshot allowing a prospective purchaser to fill out billing information for a DVD order.

FIG. 6 is a screenshot whereby a prospective seller or other user may update their membership profile on the website.

FIG. 7A is a screenshot which provides contact information for the website operator.

FIG. 7B is a screenshot showing more specific contact information and sponsorship information for prospective advertisers.

FIG. 8A presents a listing of “Equine Links” that may optionally be provided on the website.

FIG. 8B presents a listing of “Sellers” website links that may optionally be provided on the website.

FIG. 8C presents a listing of “Breeders” website links that may optionally be provided on the website.

### DETAILED DESCRIPTION

### DEFINITIONS

As used herein, the term “server” refers to any computer, mainframe, client, PDA or code-driven apparatus that may be placed in electrical communication with a global data network such as the worldwide web.

The term “animal” refers to any nonhuman mammal, or any reptile or fish.

The term “horse” refers to any animal in the equidae family.

The term “seller” refers to any person or entity advertising for the sale, lease or breeding of an animal.

The term “purchaser” means any person or entity seeking to purchase, lease or have bred an animal.

The term “mail” or “mailing” means mailing through the United States mail or through private mail courier such as UPS™ or Federal Express™.

### Description of Specific Embodiments

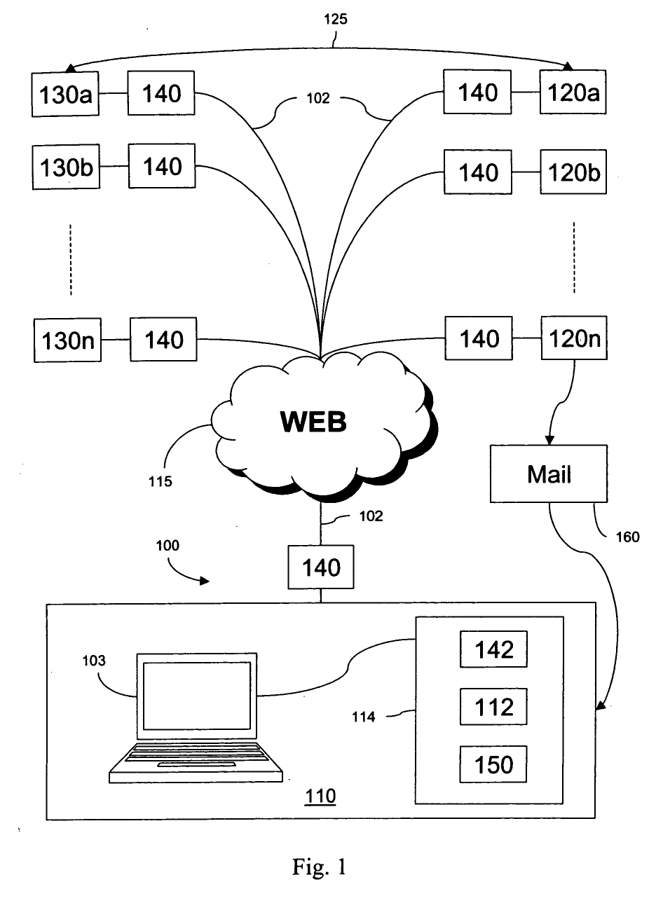

FIG. 1 presents a system 100 for facilitating the advertising of animals, in one embodiment. The system 100 first comprises a server 110. The server 110 is any software driven device that may be placed in electrical communication with a data network such as the worldwide web 115. A communication link between the server 110 and the web 115 is shown at 102. The link may be wireless, or may be a telephone or digital cable line. A modem or Ethernet card (not shown) typically connects the server 110 to the communication link 102.

In the exemplary arrangement of FIG. 1, the server 110 is a desktop computer. The computer 110 may be free-standing or may be part of a local area network. The computer 110 typically includes a user interface 103 such as a keyboard, a screen and a pointing device. The computer 110 also includes a processor unit 114 which holds software and communicates commands to and from the user interface 103. The software will include an operating system such as the known UniX™ operating system, Microsoft Windows™ operating system, or Linux™ operating system. The software will also include a plurality of applications for performing various features such as electronic mail.

The server 110 includes a website 112. The website 112 is placed in communication with the web 115 by a network interface 140. The network interface 140 is typically an internet service provider, or “ISP,” which enables the website 112 to be presented to a plurality of remotely located system users 120, 130 on the web 115. A web browser 142 is installed in the computer 110 to facilitate communication of the website 112 from the computer 110. The browser 142 may be any one of a number of commercially available browsers such as Netscape Navigator™ or Internet Explorer™. In this manner, the server 110 provides a web-based platform for a business.

The computer 110 includes a memory 150 for storage of data and instructions. The memory 150 also forms a database that holds information acquired by and generated through the website 112. The database 150 may be freestanding or may be associated with the processor 114 on the computer 110.

FIG. 1 shows a plurality of sellers 120. These are denoted in FIG. 1 as sellers 120a, 120b, etc. The term “sellers” is intended to be generic and encompasses not only prospective sellers of animals, but also sellers of services such as breeding services or leasing services. Such animals may be of any type, but are preferably show animals such as dogs, cats and horses. Alternatively, such animals may be exotic animals such as lions or tigers. For purposes of describing the drawings and operation of the website 112 herein, this disclosure will primarily refer to horses. However, it is understood that the claims below are not to be so limited unless expressly stated therein.

FIG. 1 also shows a plurality of purchasers 130. These are denoted in FIG. 1 as purchasers 130a, 130b, etc. The term purchasers is likewise intended to be generic and to encompass not only prospective purchasers of animals that are listed on the website 112, but also purchasers of services such as breeding services or leasing of an animal. As will be described further below, the purchasers 130 are able to obtain initial information concerning the horses (or other animals) through the website 112. Further, the purchasers 130 are able to order video clips of selected horses (or other animals) so as to further learn about the horses listed for sale, lease or breeding.

Each of the sellers 120 and each of the purchasers 130 also employs a network interface 140 such as an internet server operator which enables the users 120, 130 to establish contact with the website 112 on the server 110. The network interface 140 will include a web browser which enables the users 120, 130 to establish contact with the server operator's website 112 through the worldwide web 115. A communication link 102 is provided between each network interface 140 and the web, which may be either a wired or a wireless link.

In order to implement the system 100, the operator of the website 112 will solicit or receive information from a number of sellers 120 about their respective animals. Reciprocally, prospective purchasers may use the website 112 to search for animals. Also, users simply seeking information about the animals or sponsors of on the website 112 may use various pages on the website 112 to learn about the system 100 and its sellers 120 and advertisers.

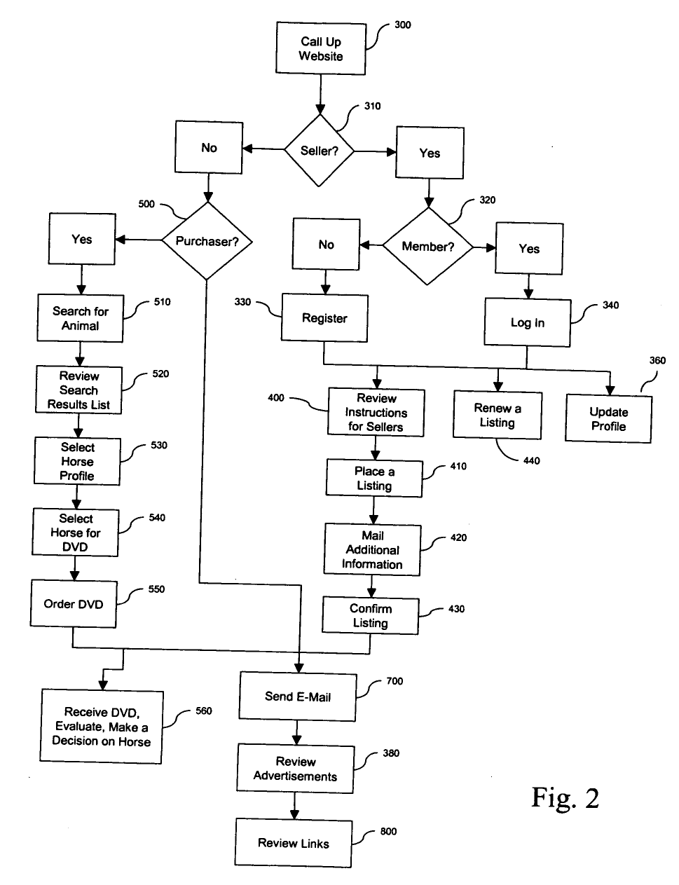

FIG. 2 presents a flowchart showing steps by which a seller 120, a purchaser 130, or another user may use the website 112. Of significance, FIG. 2, includes the step 560 that allows a prospective purchaser to order a DVD that shows video footage of, photographs of and information about selected horses.

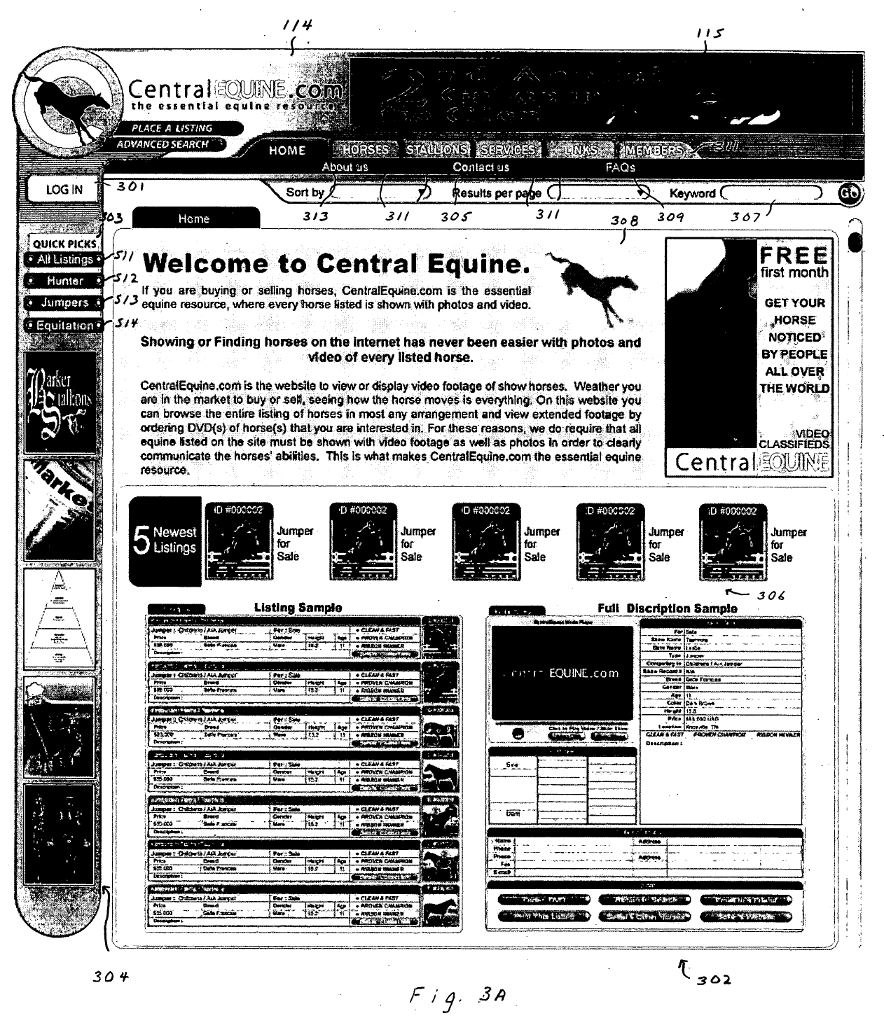

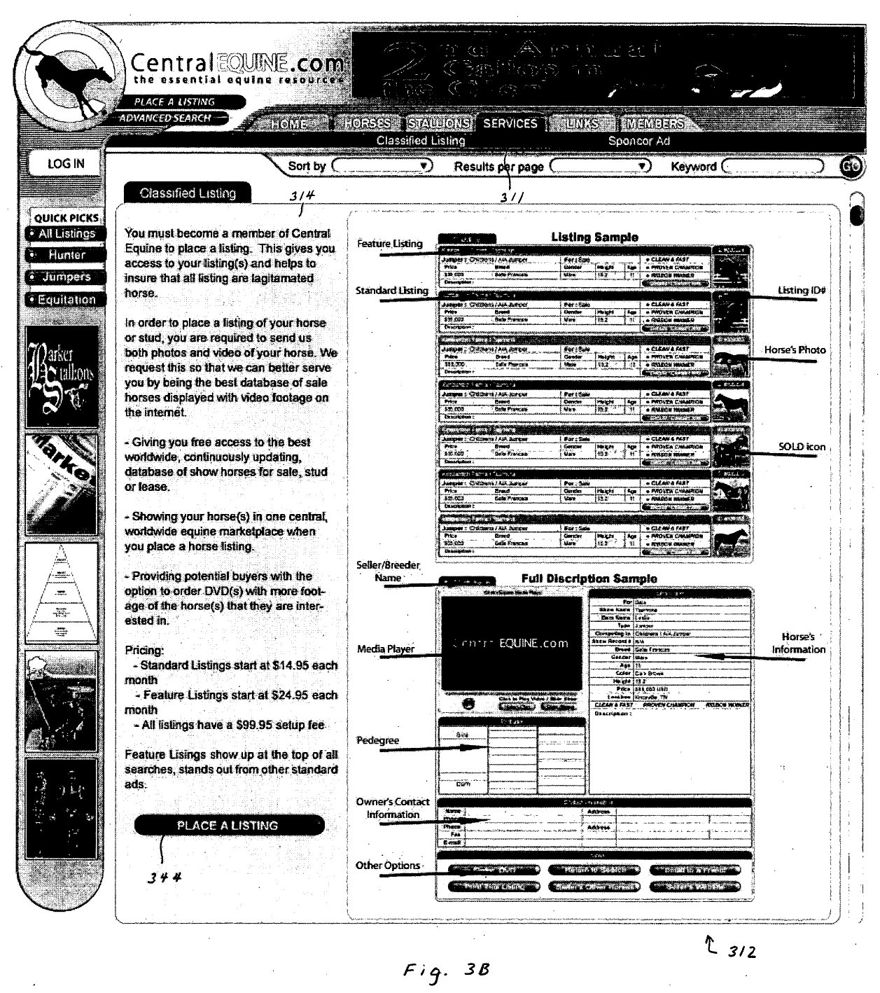

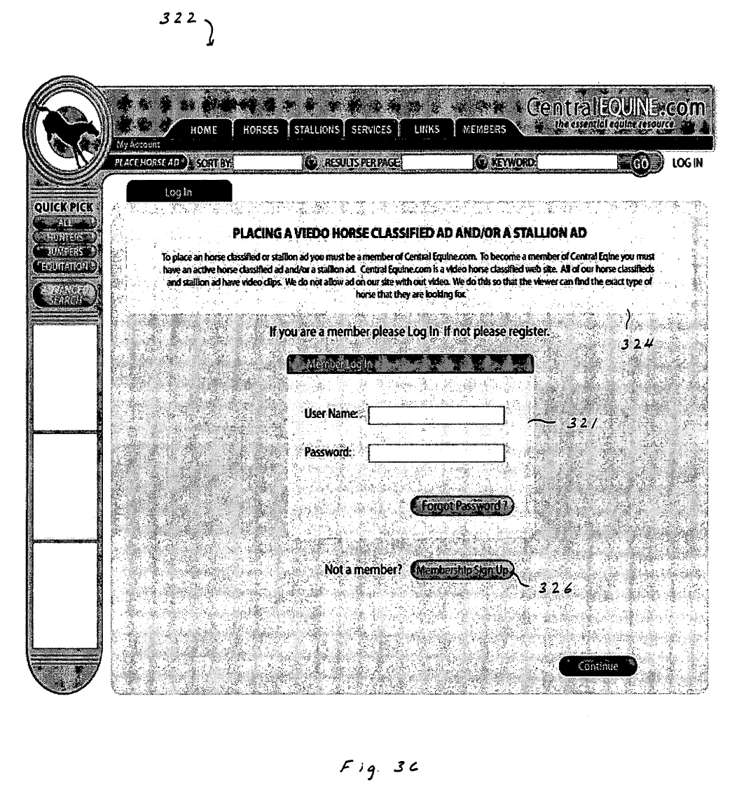

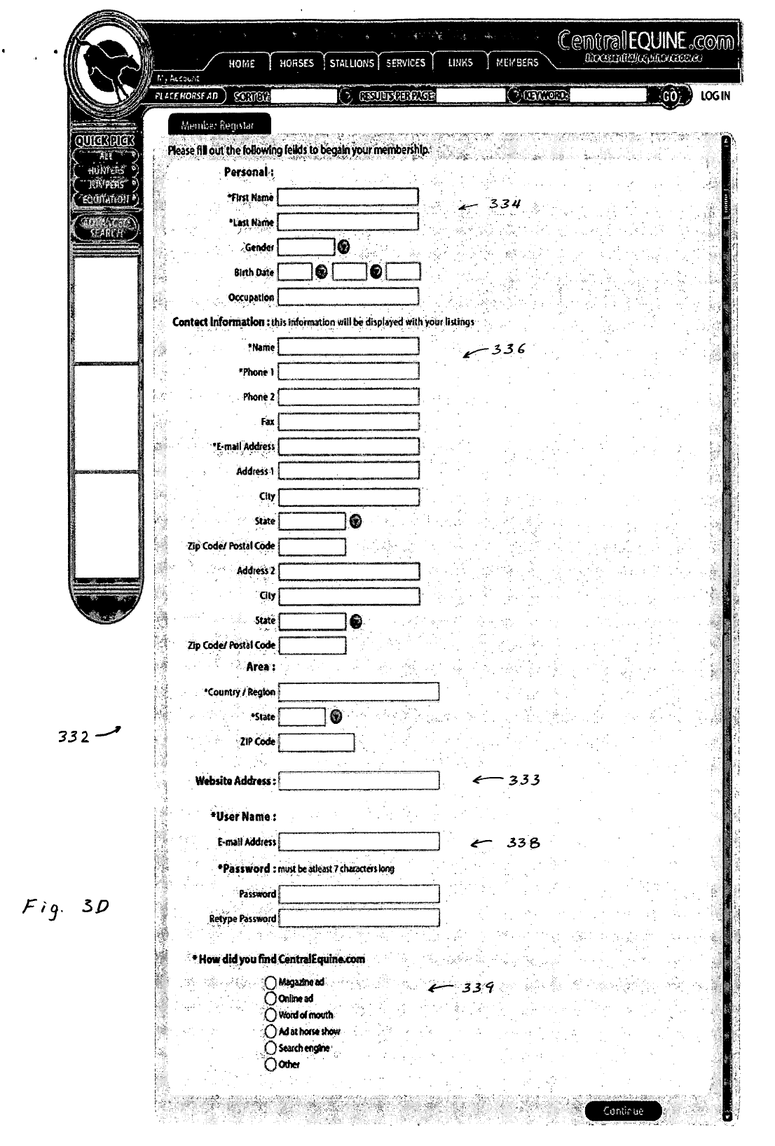

In order to access the system 100, a user 120 or 130 will call up the website 112 through data network 115. The user will be presented with a “home” or welcome page. FIG. 3A presents an illustrative screenshot 302 for a welcome page for the website 112. The illustrative welcome page 302 relates to a prospective website having a domain name “centralequine.com.” It is to be understood though that this domain name and the web page expressions presented herein are merely an example, and that the present inventions are not limited to this particular URL or web page structure.

Reviewing the welcome page 302, it can be seen that the page 302 has a variety of features. These optionally include advertiser links 304 for third parties who provide equine-related products and services, photographic links 306 for recently listed horses, and welcome statements 308. The welcome page 302 further optionally provides a log-in button 301 for members, jump links (or “Quick Pick” buttons) 303 by which a user may quickly search for specific types of horses, a contact link 305 by which a user may contact the website operator, search fields 307 for searching the website 112, an FAQ's link 309 providing answers to questions, an “About Us” link 313 and various other optional links and features. Button bars 311 are also provided, allowing the user to jump to “Home,” “Horses,” “Stallions,” “Services,” “Links” and “Members.” These latter features 311 will be discussed more fully below.

It is noted at this point that some of the screenshots for the website 112 shown herein include certain links and fields standard to the website 112. These include the log-in button 301, the jump buttons 311, the advertiser links 304, the search fields 307, the contact link 305 and the jump links 303. In addition, many pages in the website 112 will include a banner 114 that prominently displays the trademark(s) for the website and a link 115 to a preferred equine sponsor or event. These various standard features are referenced in connection with FIG. 3A and will not be pointed out or described with reference to each subsequent page unless they relate to the operation of a step being described in the flow chart of FIG. 2.

Returning now to FIG. 2, the flow chart differentiates between (1) users that are prospective sellers 120, (2) users that are prospective purchasers 130, and (3) other third party users that may enter the website 112. Step 310 asks if the user is a seller. The reason is that sellers 120 are preferably required to register with the website 112 and become members before listing any horses. FIG. 3B presents an exemplary screenshot 312 for an instructions page for prospective sellers. The instructions page 312 is accessed by clicking the button 311 for “Services.”

The instructions page 312 first includes a statement 314 reminding the prospective seller that he or she must be registered in order to list a horse on the website 112. The statement 314 also provides information 314 concerning benefits of listing a horse on the website 112, and pricing. The instructions page 312 includes the log-in button 301 by which members may log in. Alternatively, a button 344 is provided so that a seller may “Place A Listing.” The controlling software driving the website 112 will then direct the seller 120 to a log-in page if the seller has not already logged in.

Is step 320 of FIG. 2, the flow chart makes a distinction between sellers that have become members and sellers that have not. FIG. 3C presents a screenshot for a log-in page 322 for prospective sellers. The log-in page 322 provides a field 324 again reminding sellers that they must be a member of the website's service to list a horse. This page 322 invites the prospective seller to log in by entering a user name and password. The log in step of FIG. 3C is shown schematically at Box 340 in FIG. 2. A field 321 is provided on page 322 for the seller to enter a user name and password. Logging in allows the prospective seller to access a secure area of the website 112 for entering or changing data.

If the seller is not a registered user, then the log-in page 322 provides a button 326 by which the seller may access registration pages. Clicking the register button 326 will bring up a registration page 332 on the website 112. The step of becoming a registered member of the website 112 is shown schematically at Box 330 in FIG. 2.

FIG. 3D shows an illustrative screenshot for a registration page 332 for the website 112. The registration page 332 contains various fields that should be completed by the seller including, for example, personal information 334, contact information 336 , a selected user name and password 338, a website address 333 and information 339 as to how the prospective seller was directed to the website 112.

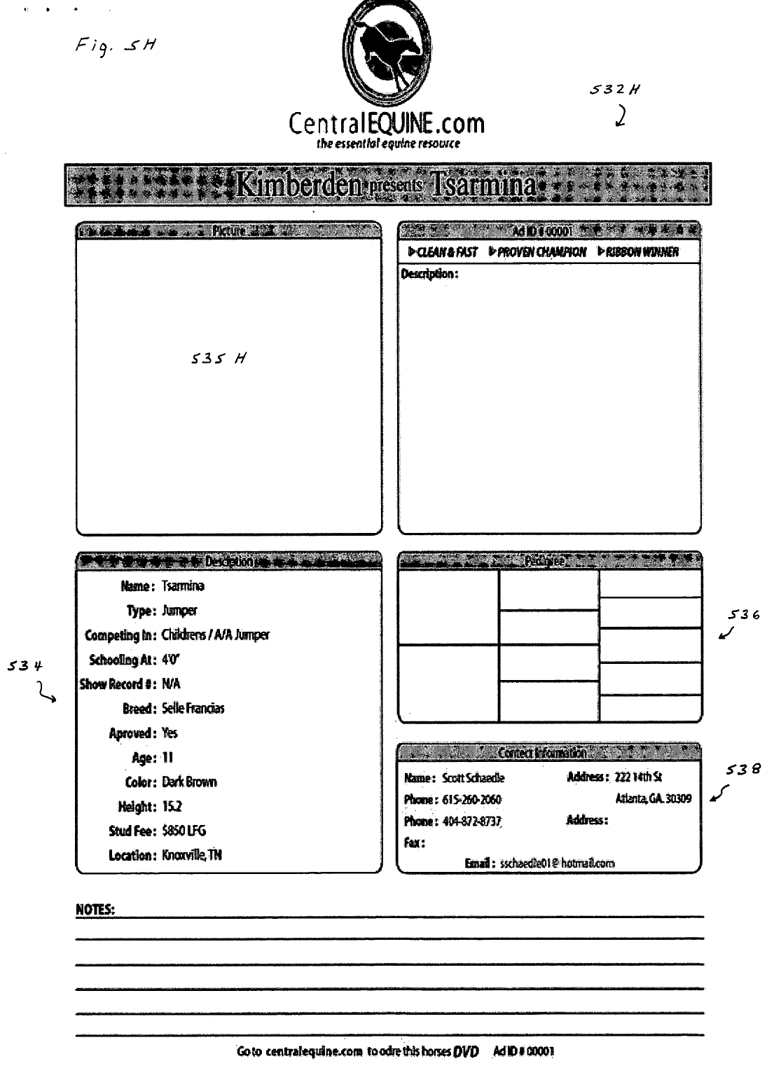

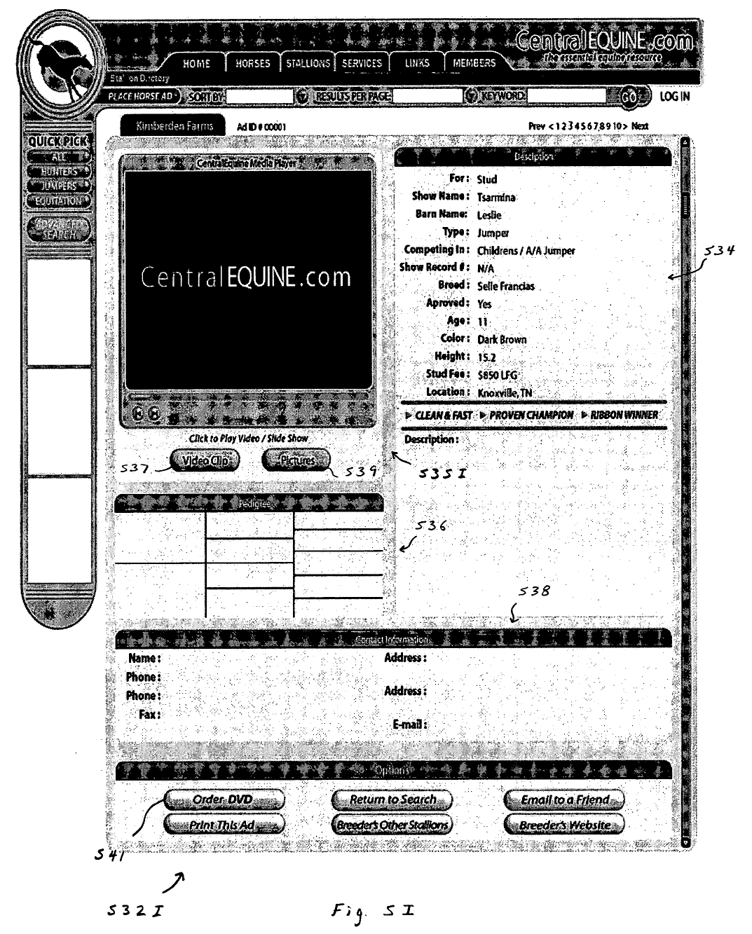

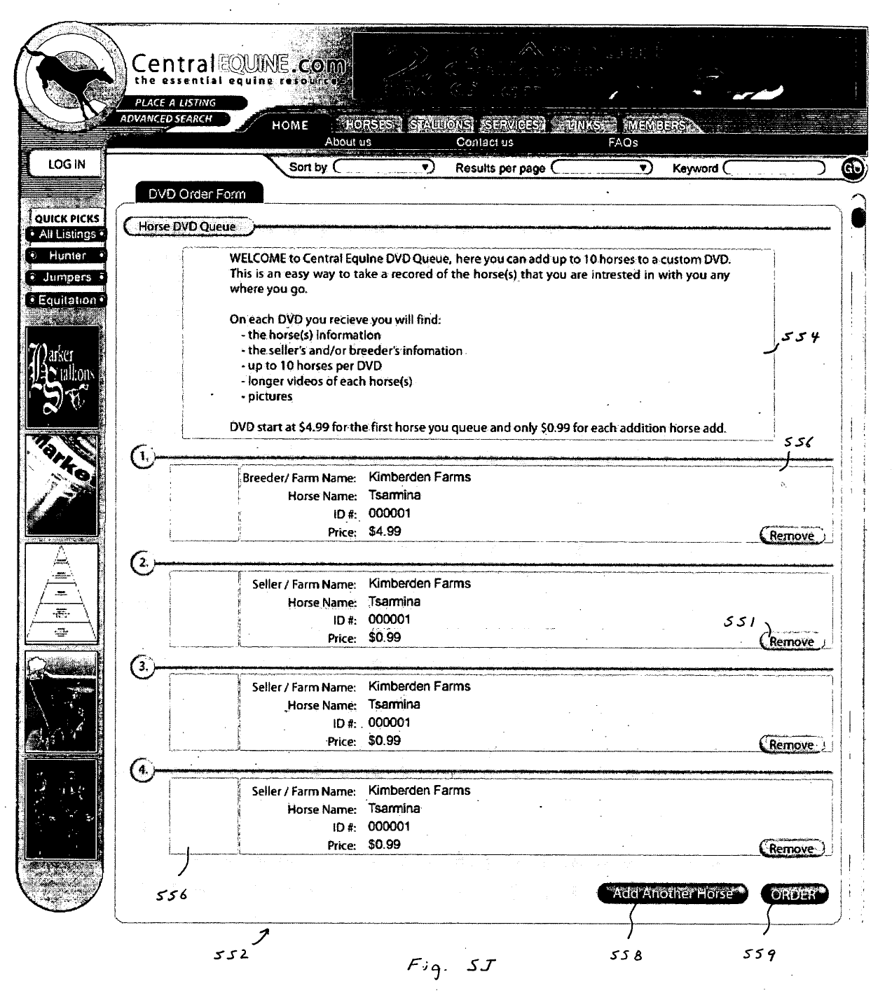

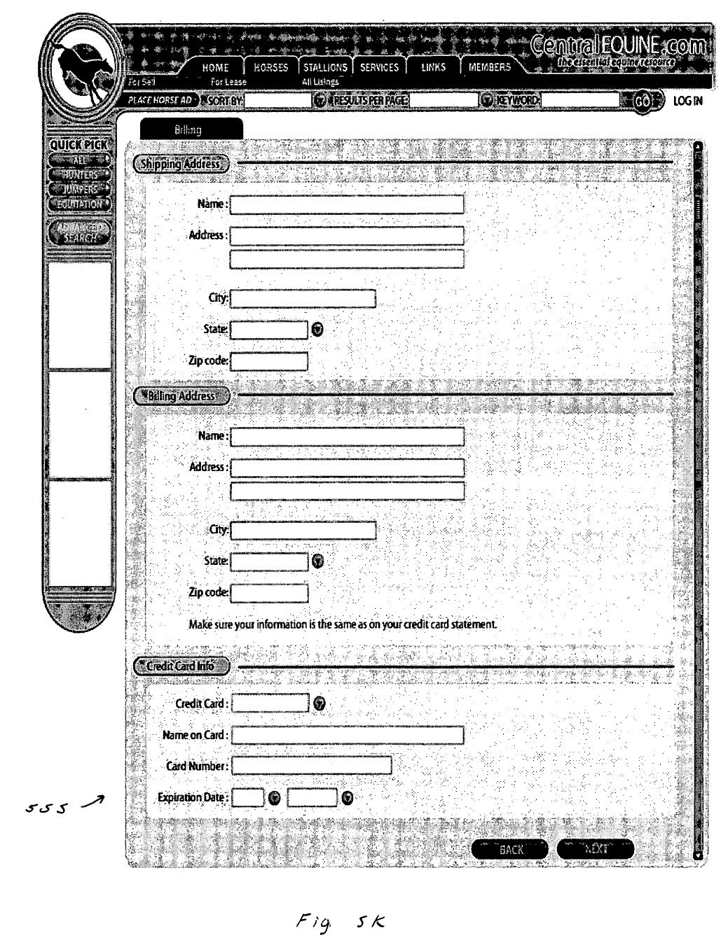

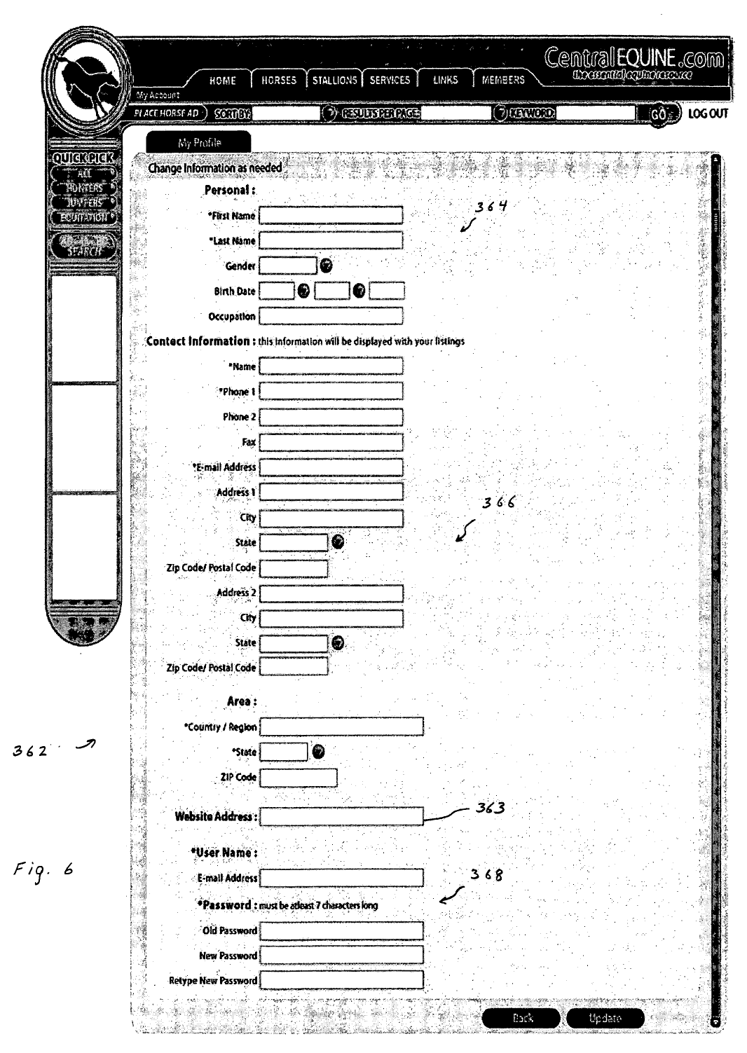

If the seller is already a registered user, and after the step of logging in 340, the seller has the option of updating his or her profile. This updating step is shown schematically at Box 360 of FIG. 2. The updating step 360 is manifested on the website 112 by a profile page 362 demonstrated in FIG. 6. FIG. 6 presents a screenshot 362 whereby a prospective seller may update their profile on the website 112. The profile page 362 contains various fields that should be confirmed by the seller and which generally mirror the information provided in screenshot 332 of FIG. 3D. This information includes personal information 364, contact information 366, a selected user name and password 368 and the website address 363. An “Update” button 361 is provided to confirm the updated information.

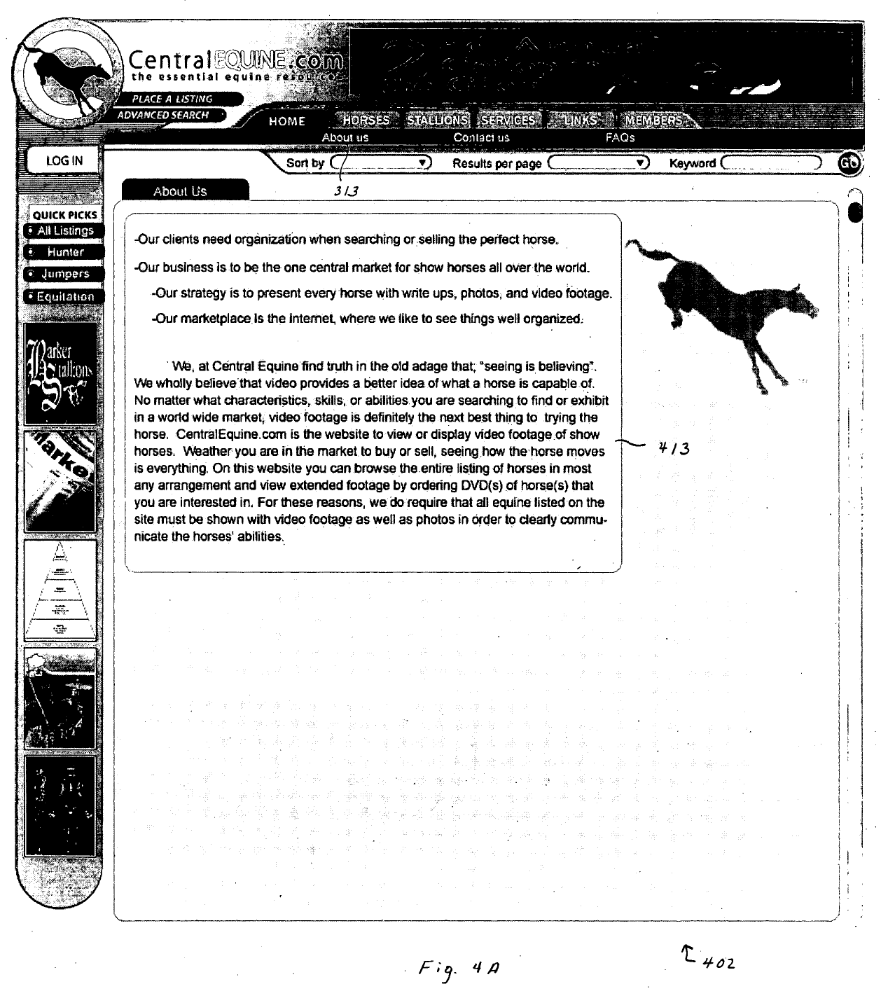

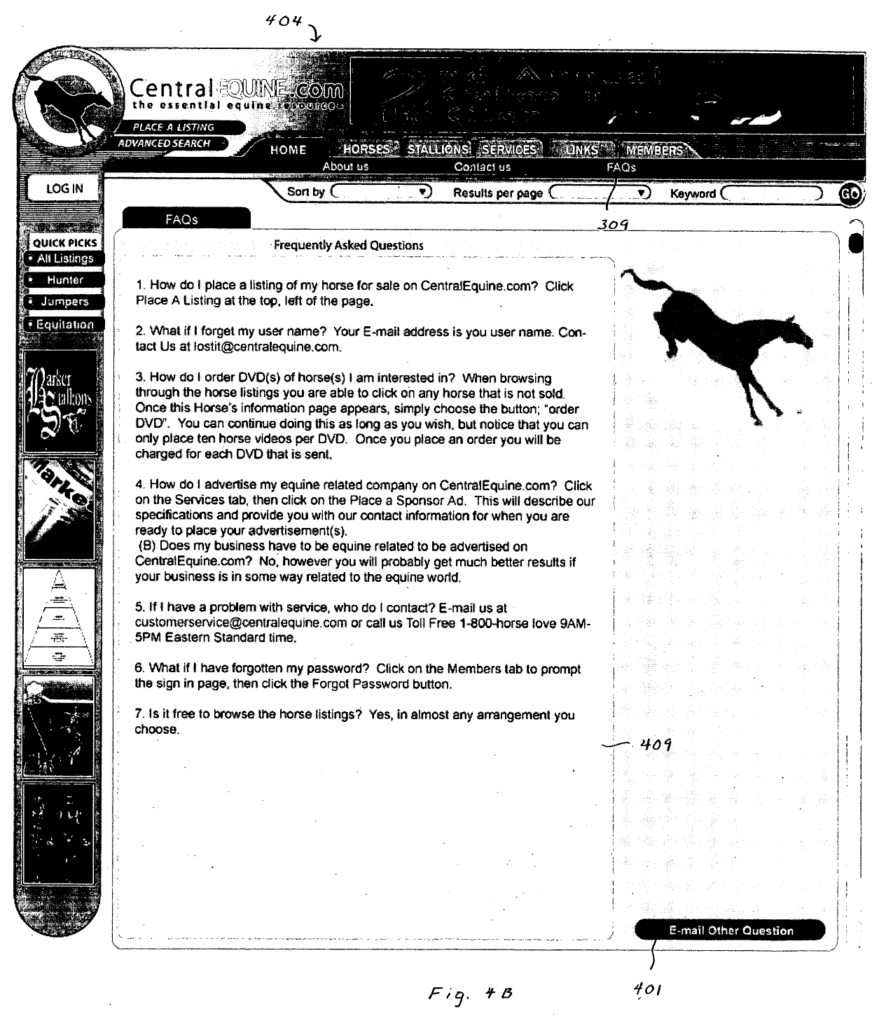

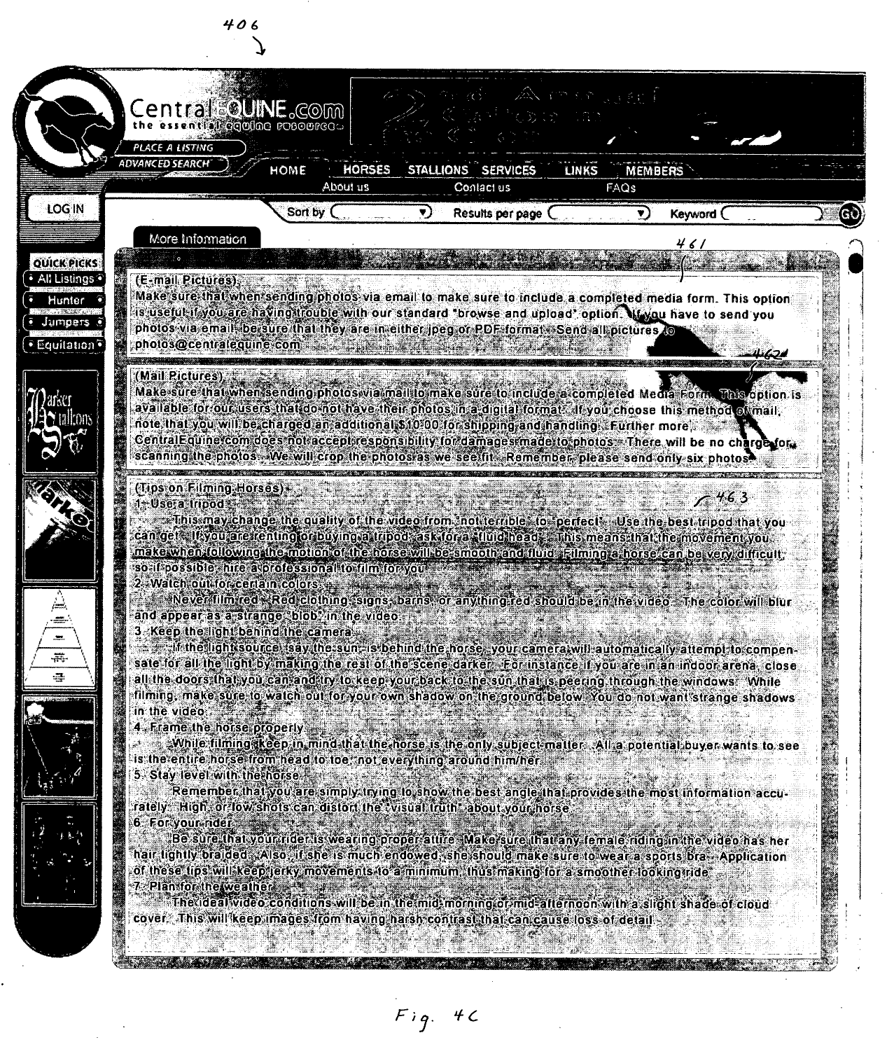

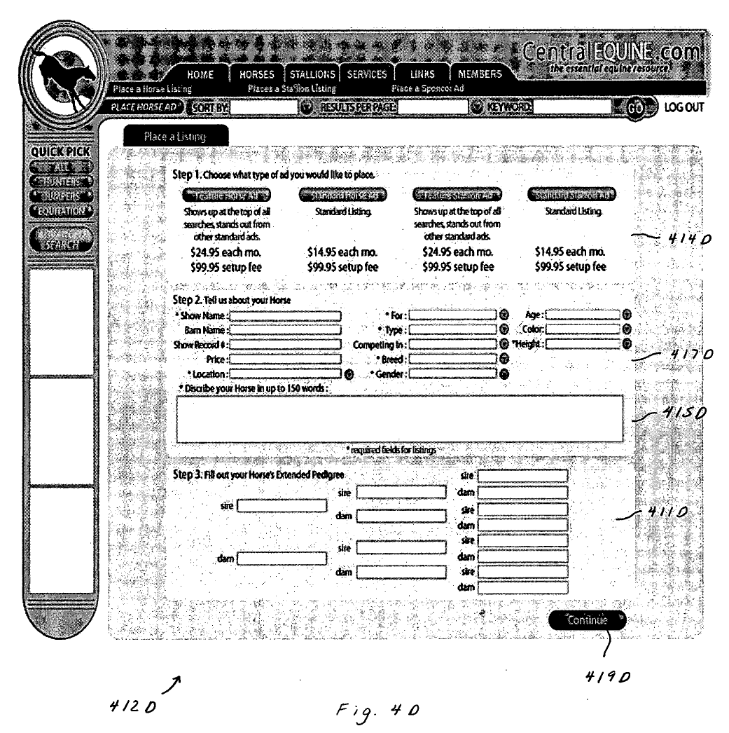

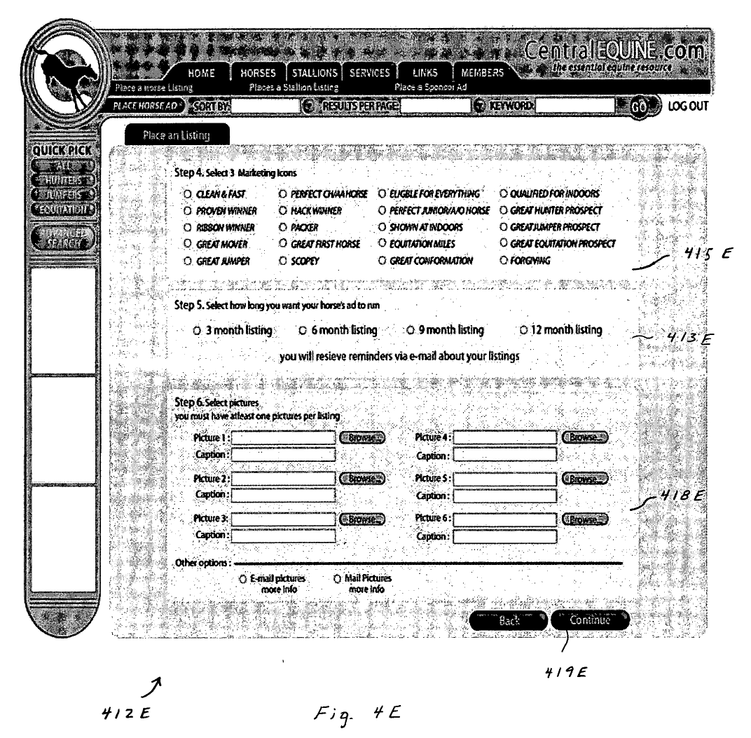

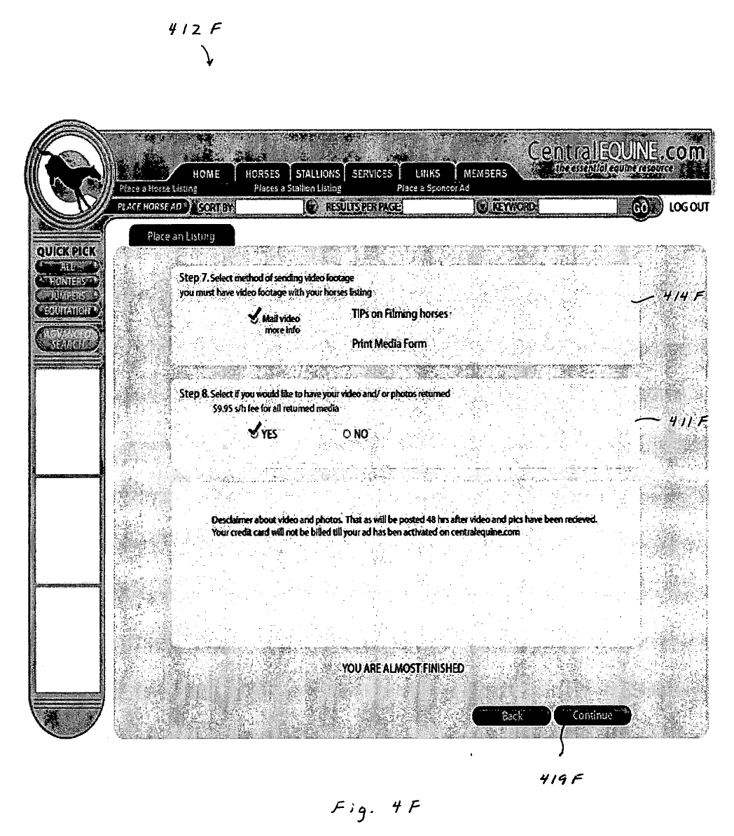

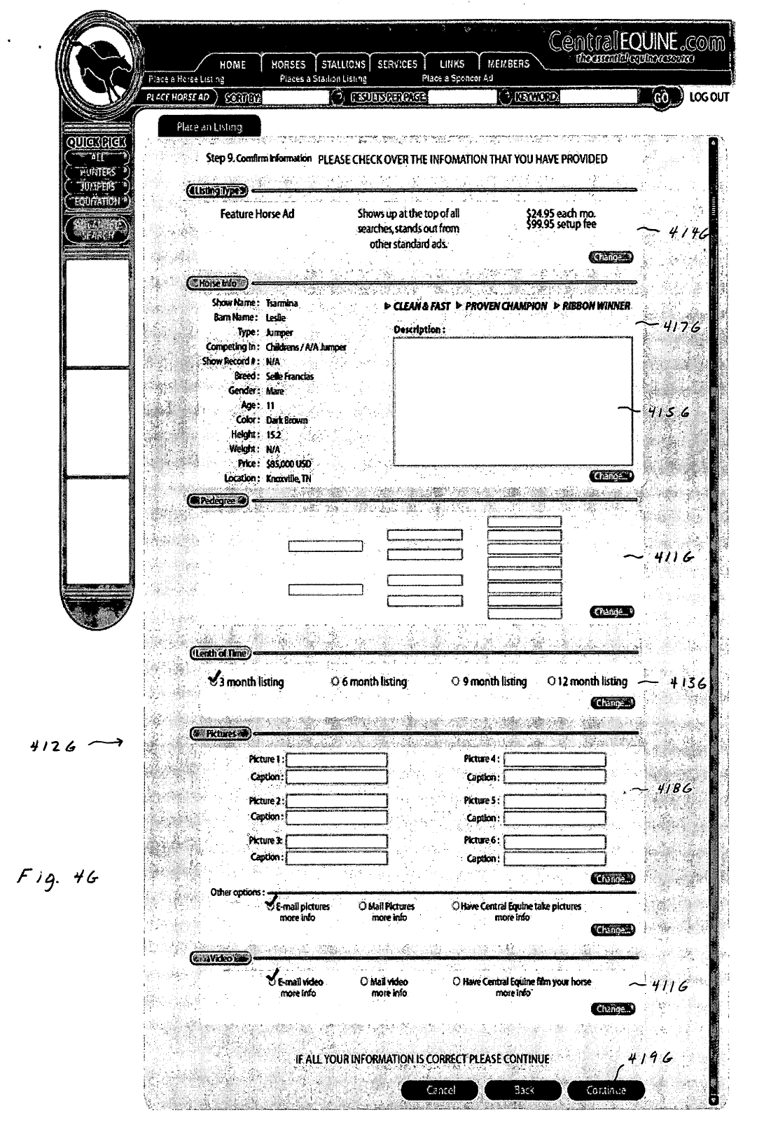

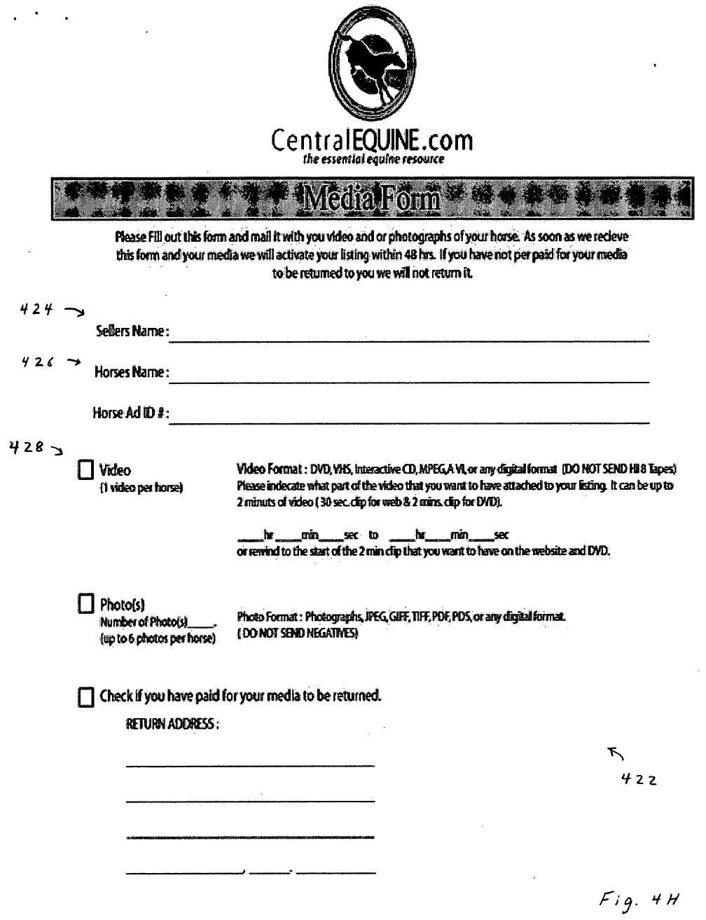

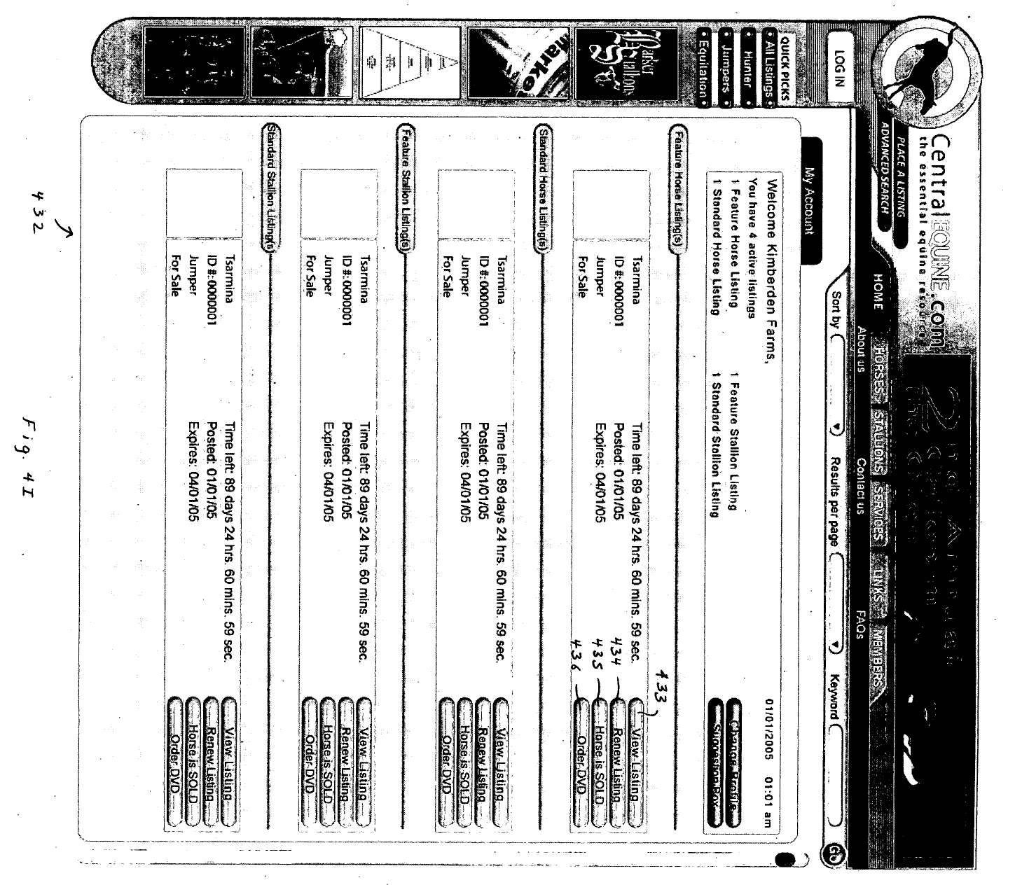

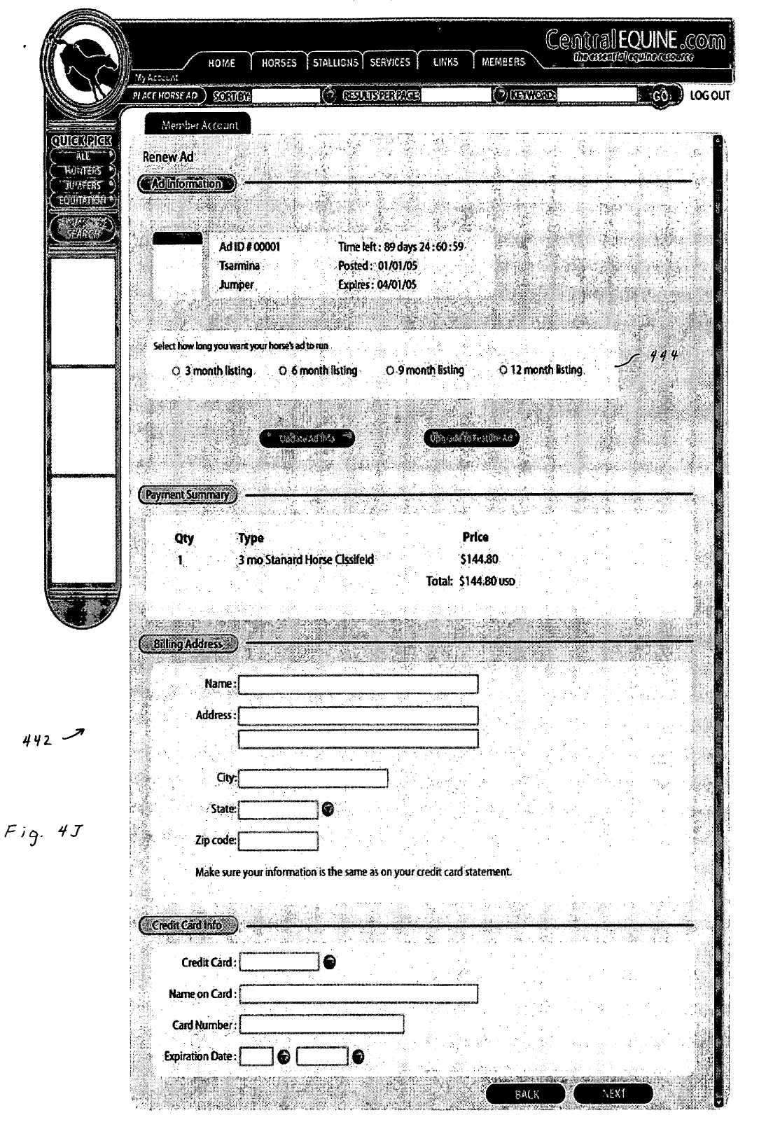

Returning again to FIG. 2, once the prospective seller is appropriately registered 330 or logged in 340, the website 112 offers the seller information and instructions for listing a horse. Box 400 of FIG. 2 shows the step by which the seller may review listing information and instructions. FIGS. 4A-4C represent screenshots through which such information and instructions may be provided.

First, FIG. 4A presents a screenshot for an informational web page 402. This informational web page 402 is accessed by clicking the “About Us” link 313. Web page 402 includes field 413 which presents information for the prospective seller. It is noted here that access to page 402 is not limited to registered members. However, the information is directed primarily to the prospective seller and so is shown as a step 400 for the seller in the flow chart of FIG. 2.

FIG. 4B presents another screenshot of a page 404 that provides information to prospective sellers of horses. The web page 404 is accessed by clicking the “FAQ” link 309. This web page 404 includes a section 409 which lists a series of “Frequently Asked Questions” along with answers to those questions. Web page 404 includes a button 401 which allows the user to e-mail additional questions to the website operator. It is again noted that access to page 404 is not limited to registered members. However, the provided answers contains important information and links for a prospective seller and so the page 404 is again described in connection with step 400 in the flow chart of FIG. 2.

FIG. 4C is yet another screenshot of a page 406 providing information for prospective sellers of horses. This web page 406 includes a section 461 instructing the prospective seller as to e-mailing pictures of a horse to be listed. The web page also includes section 462, which instructs the seller on mailing photographs to the server operator. A link is provided in this section 462 for a “Media Form.” An example of a Media Form is provided in FIG. 4H, described below. Finally, section 463 is provided to give tips to the prospective seller as to filming the horse. While not stated, the video may also be mailed to the server operator with the Media Form of FIG. 4H.

It is contemplated that the seller 120 himself will create (or have created) video footage through analog tape recording. In this instance, the seller 120 will then mail the videotape to the server operator, who must then convert the video footage into a digital file to be placed in the database 150. At least a portion of the video footage may be placed by the server operator on the website 112 for online viewing by prospective purchasers 130.

In some instances, the server operator may go to the locale of a seller 120 in order to acquire the video footage. The server operator may send a professional videographer who charges a fee for his videotaping services. As discussed more fully below, this option may be elected by checking a box in section 411G shown in FIG. 4G. In this way, professional grade video clips are assured. These video clips would preferably be in digital form and could be downloaded onto a DVD-R (recordable digital video disc) or DVD-RAM (DVD with random access memory) for transport or mailing to the server. Alternatively, the digital file may be electronically transmitted to the server operator. The server operator would then download the digital video file onto the database 150.

Returning to FIG. 2, the next step shown on the flow chart is the placement or renewal of a listing. The step of listing a horse is shown schematically at Box 410 of FIG. 2. The listing of horses on the website 112 is the backbone of the website business, and without an inventory of listings the business model fails. In order to provide the equine services, the server 110 is set up for operation of a web-based business. Information is solicited and obtained from prospective sellers concerning horses that are to be placed on sale. The information includes a video clip for each horse. In this way, a library of video files for horses will be established.

The listing step 410 may be for the purpose of selling a horse, leasing a horse or making a horse available for breeding. The step of listing a horse is initiated by clicking the “Place a Listing” button 344 of web page 312. Again, this page 312 is presented in FIG. 3B. Hitting the “Place a Listing” button 344 will direct the prospective seller to a series of pages by which data may be entered into the website 112.

FIGS. 4D-4H provide sequential illustrative screenshots 412D, 412E, 412F, 412G and 412H for listing a horse using the system of FIG. 1. First, screenshot 412D begins with a section 414D that asks the prospective seller what type of ad they would like to place. The seller is given the choice between placing a “Feature” ad and a “Standard” ad. corresponding price structures. A “Feature” ad will be placed most prominently in any search result list, while a “Standard” ad is listed thereafter. Corresponding price structure is also provided.

Web page 412D includes various fields that are to be filled in by the prospective seller about the horse. In field 417D, the seller completes certain profile data for the horse. Drop down menus may be provided to allow the seller to simply select profile data in lieu of manual entry. Field 415D permits the seller to type in additional descriptive text. Finally, web page 412D provides a field 411D by which pedigree information for the horse may be entered.

After the prospective seller has entered appropriate descriptive data for his or her horse into the data fields of page 412D, the seller clicks the “Continue” button 419D. This advances the website 112 to the next listings page. This page is shown as screenshot 412E in FIG. 4E. Web page 412E provides additional fields by which data may be entered by the prospective seller. Field 415E shows a list of descriptive terms that may be selected to describe the horse being listed and the length of the ad. In field 413E the seller selects the length in which the listing will run. Field 418E permits the seller to list up to six photographs showing the horse. A caption may be written by the seller in field 418E describing each photograph. The photographs may be attached as electronic files and then e-mailed to the server operator, or they may be sent via public mail courier. Box 160 of FIG. 1 schematically illustrates the optional step of a seller sending information such as photographs to the server operator via public mail.

After the prospective seller has entered appropriate descriptive data for his or her horse into the data fields of page 412E, the seller clicks the “Continue” button 419E. This advances the website 112 to the next listings page. This page is shown in one embodiment as screenshot 412F in FIG. 4F. Web page 412F first includes section 414F. This section reminds the prospective seller that he must have video footage to list a horse on the website 112. A mailing address is provided for the seller. In addition, a link is provided in section 414F for printing out the Media Form of FIG. 4H and for reviewing tips on filming horses. Field 411F is also provided to allow the seller the option of having his or her video and photos returned at a later date.

After the prospective seller has entered the appropriate data for his or her horse into the data fields of pages 412D, 412E and 412F, the seller clicks the “Continue” button 419F. This advances the website 112 to the next listings page 412G. A screenshot for this page 412G is seen in FIG. 4G. The fields of page 412G generally mirror the fields of pages 412D and 412E. For example, field 414G relates to field 414D, field 413G mirrors field 413E, field 418G mirrors field 418E, field 415G relates to field 415D and 415E, and so forth. The repetitive fields are provided to give the seller an opportunity to review his or her data and make desired changes.

After the prospective seller has reviewed and approved the fields of web page 412G, the seller clicks the “Continue” button 419G. This advances the website 112 to a payment page (not shown). Conventional secure means may be employed for receiving credit card data from a prospective seller. A telephonic or digital cable interface may be used to make contact with a credit authorization system such as a credit card validation organization such that system users who enter their credit card information to pay for services offered by the server 110 may be billed for the services. In one aspect, the credit card or other payment data is entered through a link with VeriSign™. VeriSign™ provides a confidential payment structure such that the seller's credit card data is never seen by the website operator. VeriSign™ also informs the website operator when the payment transaction is completed. The website operator preferably waits up to thirty days for verification of payment, after which the prospective seller's listing data is purged from the database 150. If confirmation of payment is received, controlling software for the website 112 allows the website operator to enter the seller's data from the database 150, causing it to be listed on the website 112.

After the profile data has been entered by the prospective seller into the website 112 and after payment is made, the seller mails additional information to the website operator. This mailing step is shown at Box 420 of the flow chart of FIG. 2. As noted above, a form is specially provided in the website 112 to facilitate the mailing of additional information. FIG. 4H is an illustrative screenshot for a form by which a prospective seller may provide additional information to the website operator. This form is referred to in the website 112 as a “Media Form” and is presented as illustrative page 402H.

Web page 402H provides field 424 for the seller to identify himself or herself. Field 426 is provided for the seller to identify the horse that has been listed. Finally, field 428 allows the seller to identify the enclosed video footage and photographs. Specific formats are listed for the video and photographs. If a video received is an analog tape, then the tape is converted to a digital video file. The digital file of the video clip is uploaded onto the database 150 for the website 112. A portion of the video clip may be made available on the website 112. This encourages customers to purchase DVD's with fuller video footage. It also recognizes the reality that full video clips exceed the practical bandwidth of the website or customer, at least using present technology and tools commonly in the hands of horse farms and owners.

The website 112 allows a seller to confirm his or her listings. The confirmation step is depicted by Box 430 of FIG. 2. FIG. 41 shows a screenshot for an illustrative web page 432 by which a seller may review listings under their account. Each horse is listed separately. Horses may be sorted by “Feature Horse Listing” at the top of the list, and “Standard Horse Listing” below. Each horse listing provides a set of buttons that may be clicked. These may include a “View Listing” button 433, a “Renew Listing” button 434, a “Horse is Sold” button 435, and an “Order DVD” button 436.

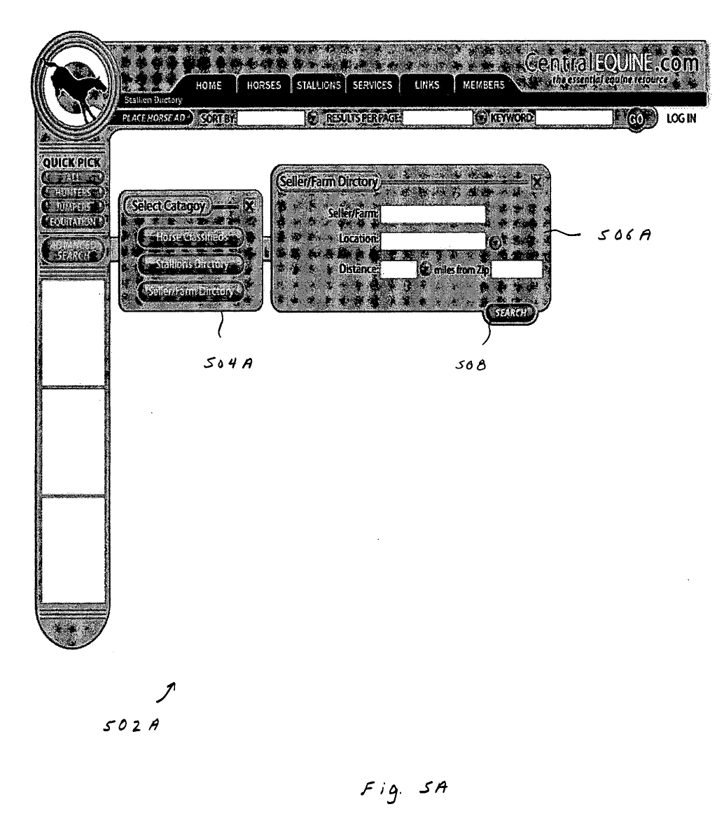

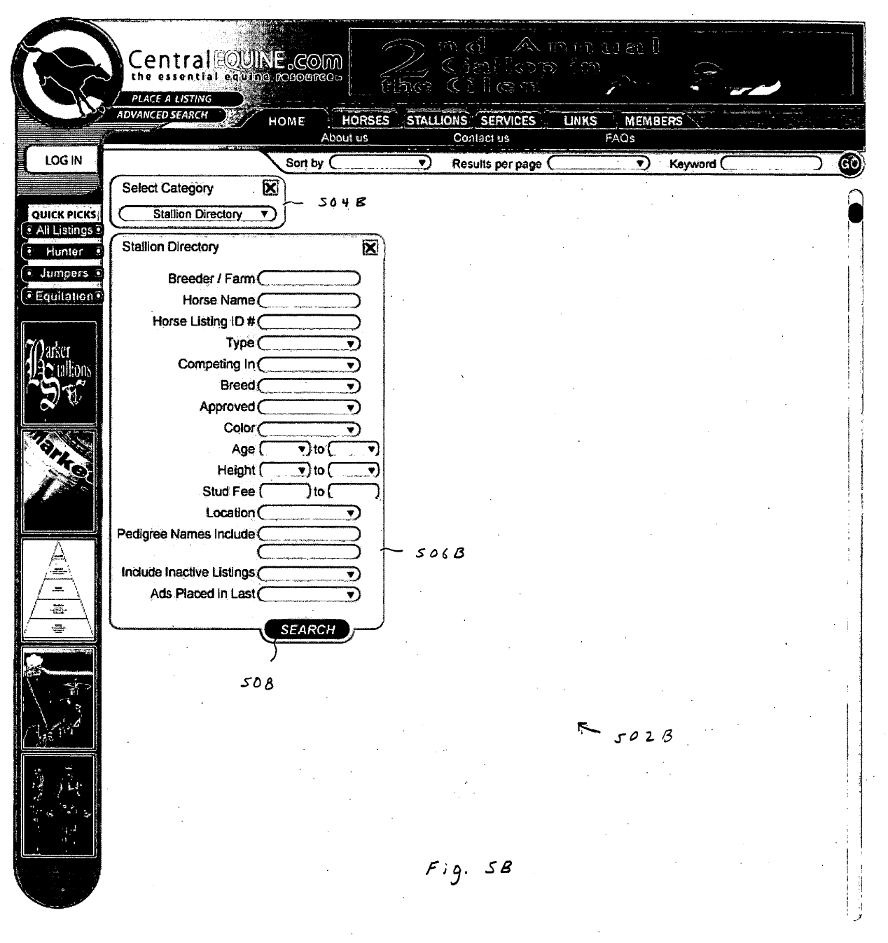

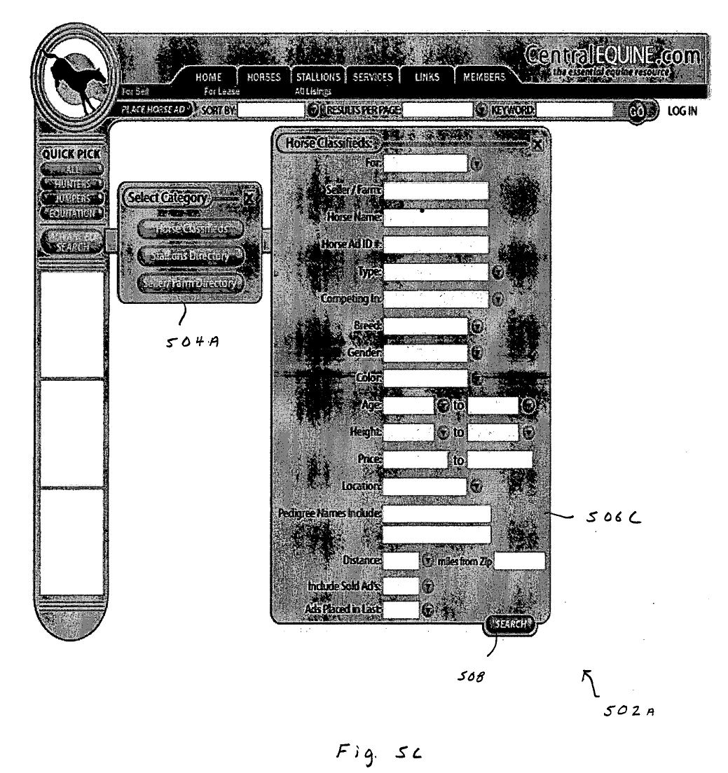

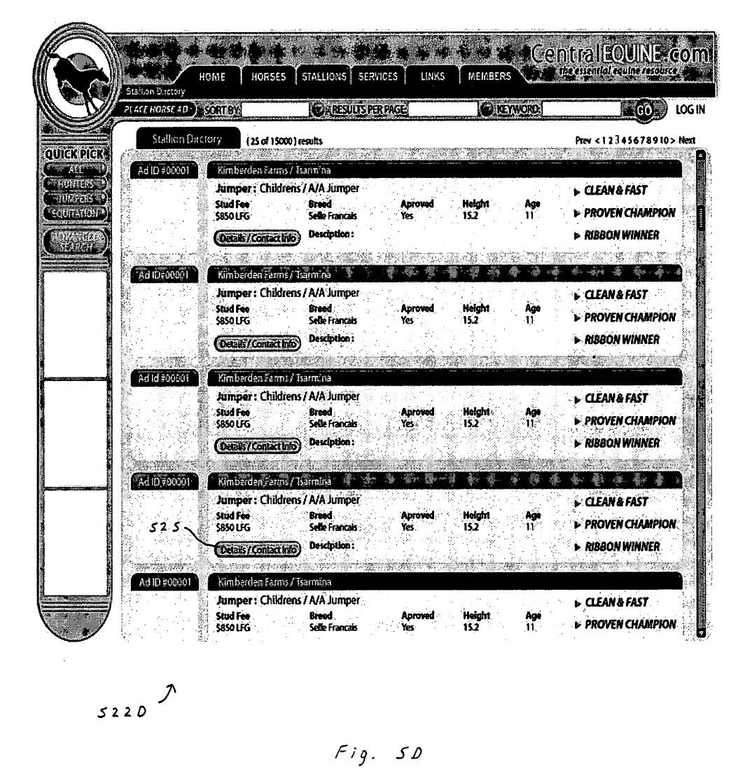

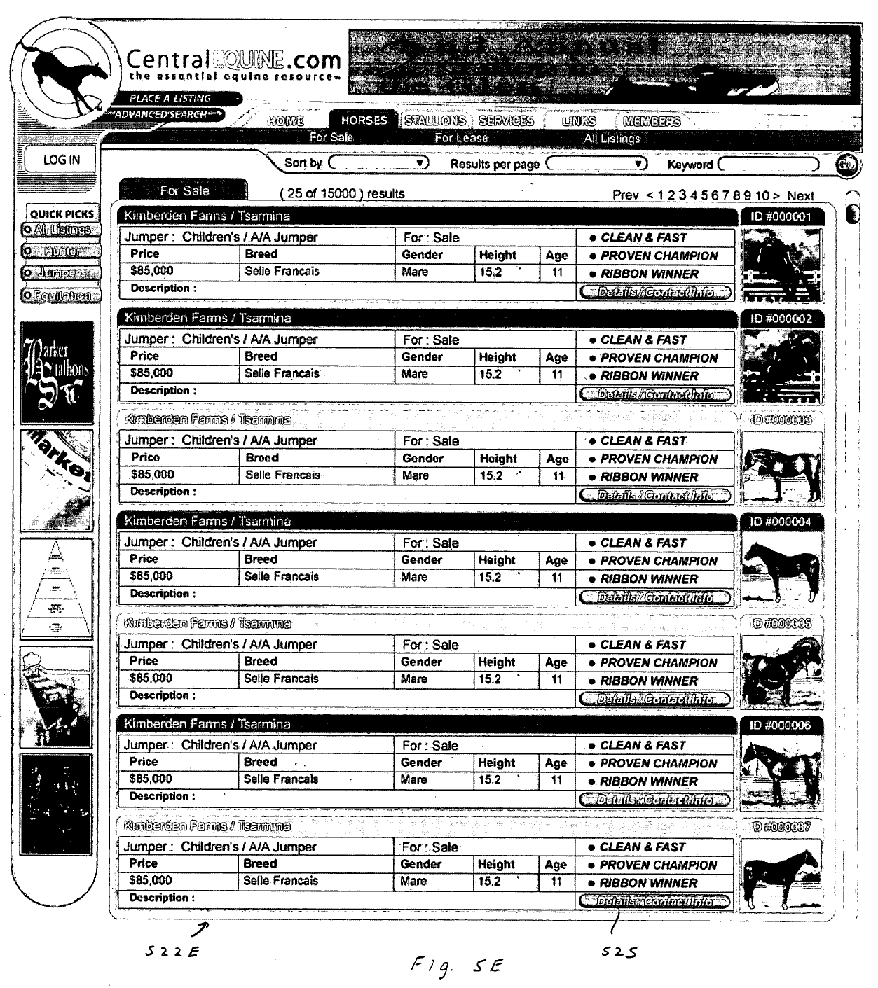

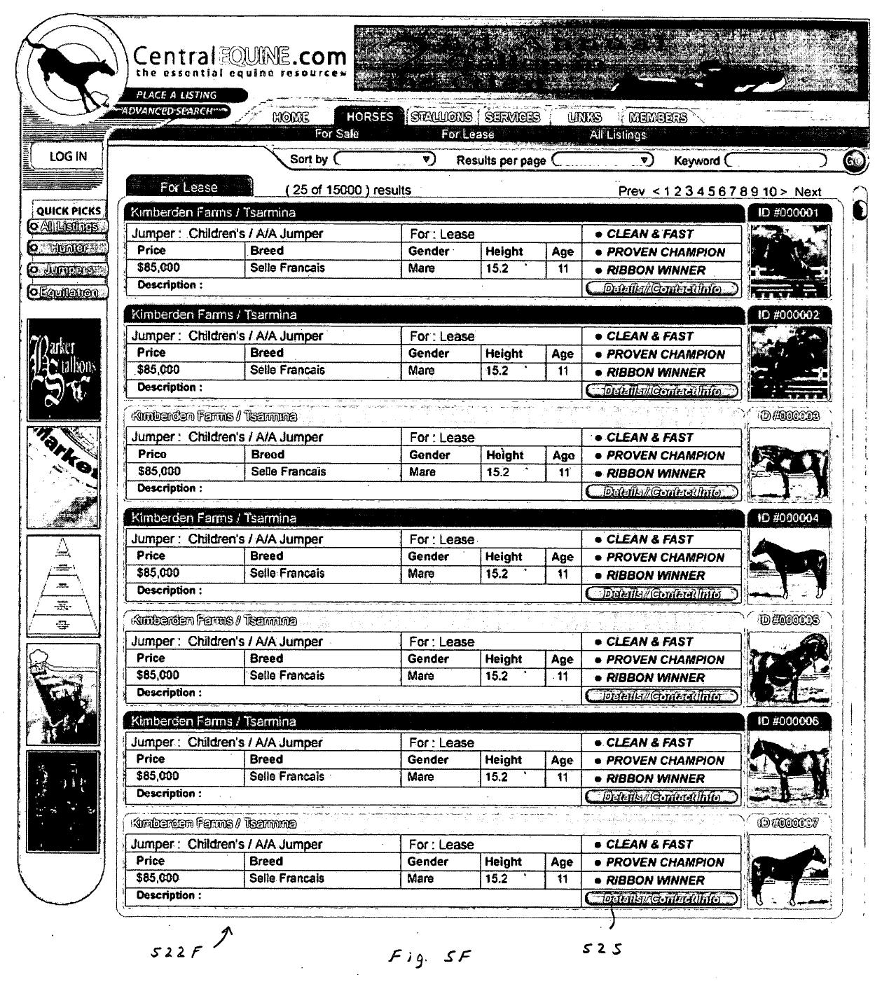

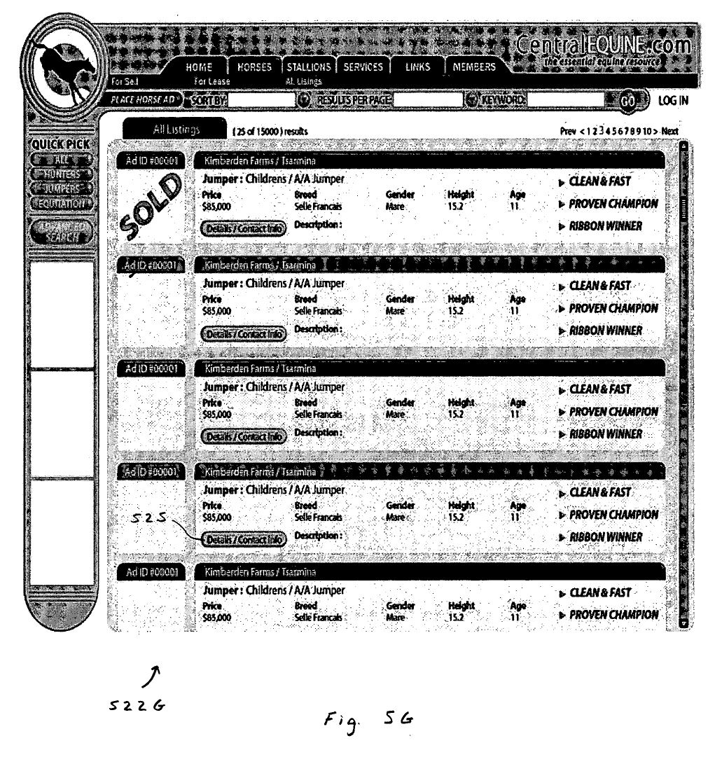

The “View Listing” button 433 permits the seller to view the advertisement for his horse as shown on the website 112. An exemplary listing page is shown at FIG. 5G, and will be described more fully below.

The “Renew Listing” button 433 permits the seller to extend the advertisement for the horse. This may be done if the horse is placed for sale, but has not yet sold. Alternatively, this may be done if the horse is being posted for breeding or for leasing and the seller wishes to again offer the horse's services. Box 440 of FIG. 2 schematically demonstrates the step of renewing a listing. Because the step of Box 440 is practiced well after the horse has been listed, it is shown parallel to the listing step of Box 410. FIG. 4J presents an exemplary screenshot 442 for renewal of a listing. Field 444 is provided to permit the seller to select the renewal period.

Returning to FIG. 41, the “Horse is Sold” button 435 permits the seller to inform the server operator that the horse has been sold. This informs the website operator that the listing may be removed from the website 112. Alternatively, the algorithm driving the website 112 may place a “Sold” sign over the listing until the listing time expires.

Finally, the “Order DVD” button 436 allows the seller to order a DVD that shows the full video clip of the listed horse that is available to prospective purchasers. Under the business model for the website 112, the DVD feature is primarily targeted to prospective purchasers so that they my gain additional insight into a horse before contacting the seller directly. However, the “Order DVD” button 436 allows the seller to also order a DVD of their own horse. This might be done for sentimental reasons after the horse is sold, or because the seller seeks to send the DVD himself to a prospective purchaser apart from the server operator.

Returning now to step 310 in the flow chart of FIG. 2, if the user is not a seller, then a determination is made as to whether the user seeks to search for a horse as a prospective purchaser. This subsequent determination is illustrated at Box 500. If the user is a prospective purchaser, then they move to Box 510 to search for a horse. It is noted that the website 112 is preferably structured so that searching may be done without the user being registered or having to log in.

Searching for a horse may be done in one of several ways. With reference again to FIG. 3A, the prospective purchaser may click one of the “Quick Pick” buttons 303. In the illustrative screenshot 302, these buttons include an “All Listings” button 511, a “Hunter” button 512, a “Jumpers” button 513, and an “Equitation” button 514. Alternatively, the prospective purchaser may click one of the upper button bars 311. These allow the prospective purchaser to jump to “Horses” or to “Stallions.” “Horses” refers to horses that are for sale, while “stallions” refers to horses being offered for breeding. It is noted that these references are merely for purposes of illustration and that other terms and website architecture may be used for animal searching.

As yet another alternative, the prospective purchase may click the “Advanced Search” button shown on web page 302. This will open up a page such as screenshot 502A shown in FIG. 5A. Screenshot 502A allows the purchaser to select a category to search, such as sellers “Horse Classifieds,” “Stallions Directory,” and “Seller Farm Directory.” This is shown in section 504A of page 502A. After selecting a category, the purchaser may then review horses from the selected source, e.g., from the “Seller Farm Directory.” This is demonstrated in section 506A of page 502A.

FIG. 5B demonstrates an optional architecture for such a search page. Here, section 504B provides a drop-down menu for the categories. The searcher has chosen the “Stallions Directory.” Field 506B then opens for more specific searching of the stallions directory, if desired.

FIG. 5C demonstrates another view of the search web page 502A. Here, the prospective purchaser has chosen to search the “Horse Classifieds” in field 504A. “Horse Classifieds” indicates that the search is for horses that are for sale. Section 506C of web page 502A allows the purchaser to search for horses according to more specific criteria which may be provided through drop down menus. A “Search” button 508 is provided for the prospective purchaser to activate the search.

After the prospective purchaser has selected a directory or category for searching, a results list is generated by the website 112. The list is then reviewed. This review step is shown schematically at Box 520 of FIG. 2. FIG. 5D presents an illustrative search results list at screenshot 522D. This search results list 522D is for a list of stallions to be bred as might be generated from the search from FIG. 5B. A stud fee can be seen associated with each horse.

FIG. 5E is a screenshot 522E showing a search results list generated from the search of FIG. 5C. In this respect, the list shows horses that are for sale. A price can be seen associated with each horse.

FIG. 5F is a screenshot 522F showing a search results list generated from a search for horses that are listed as being for lease. FIG. 5G is a screenshot 522G showing a search results list generated from a search for “all listings” of horses.

In the search result list of each of FIGS. 5D, 5E, 5F and 5G, a link 525 is provided for each horse. The link 525 is entitled “Details/Contact Info.” The prospective purchaser may click this link 525 to learn more about the horse and the associated seller. This selection step is represented by Box 530 in FIG. 2.

FIG. 5H presents an illustrative details page 532H generated from clicking one of the links 525 in FIG. 5E. Profile data for the horse is provided in section 534; pedigree information for the horse is presented in section 536; and contact information for the seller is provided in section 538. At this point it is noted that negotiations for sale or breeding of the horse may be undertaken directly between the prospective purchaser and the prospective seller. The website and its operator facilitate the advertisement of the horse, but preferably does not consummate the sale or act as an auction site.

The web page 532H also includes a media section 535H . This media section 535H includes one or more photographs (not shown). The photographs have been provided by the seller in connection with steps 410 and/or 420. The photographs may be edited or cropped by the operator before listing on the website 112. It is preferred that video footage for each horse also be provided. Video footage would have to be ordered by the purchaser through a DVD order for it to be viewed.

FIG. 5I presents an alternate form for a details page 532I. This page 532I also provides profile data 534 for the horse, pedigree information 536 for the horse, and contact information 538 for the seller. The details page 532I also provides a media section 5351. However, in this page 532I the media section 5351 provides both photographs and video footage. The purchaser may click a “Video Clip” button 537 to view at least a portion of the video footage provided by the seller, and may click a “Slide Show” button 539 to view the individual photographs.

The details page 532I also contains an “Options” section 539. Various buttons may be clicked under the Options section 539 including an “Order DVD” button 541. The website 112 includes controlling software such that pressing the “Order DVD” button 541 permits the prospective purchaser to select that horse for inclusion on a DVD. The DVD will be sent to the purchaser by the operator of the website 112. Preferably, the DVD will include the full video footage provided by the prospective seller (or an edited but nevertheless substantial portion thereof), and the photographs in slide show format. It is preferred that fewer photographs and a shorter length of video be provided on the website 112 at section 535I as compared to what would be provided through a DVD order. This encourages the prospective purchaser to order a DVD. It also recognizes the reality that current technology does not allow the full video to be delivered to most user interfaces 140.

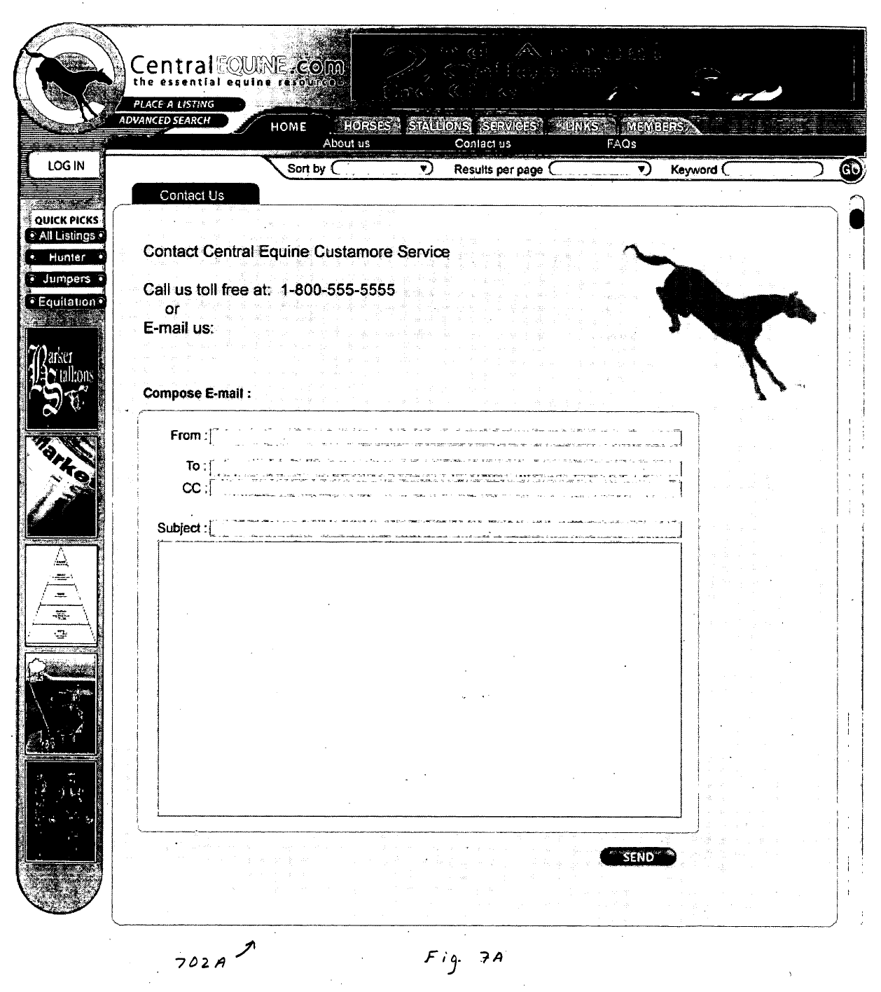

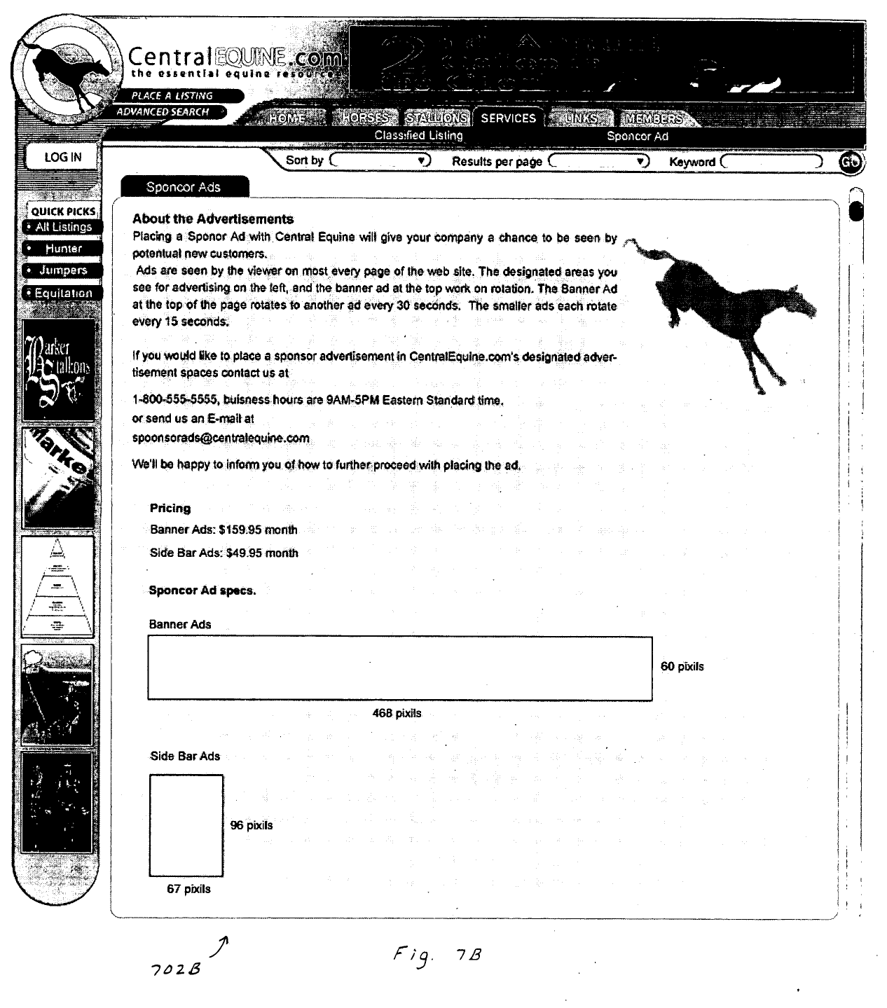

The step of selecting a horse for inclusion on a DVD is provided by Box 540 of FIG. 2. It is preferred that this step 540 be executed electronically by pressing the button 541 on page 532I. However, the present disclosure permits the order to be done over the telephone or through separate written request. For example, an e-mail could be sent using page 702A shown in FIG. 7A, discussed below.

A prospective user may order video footage for multiple horses. FIG. 5J is a screenshot for page 552 showing a list of horses that have been selected by a prospective purchaser for a DVD order. This list was generated as a result of the purchaser hitting the “Order DVD” button 541 on four separate occasions. Four separate horses are listed in separate fields 556. To list more than one horse, a button 558 entitled “Add Another Horse” is provided. Thus, when the “Order DVD” button 541 is clicked, the purchaser may subsequently click the “Add Another Horse” button 558. This sends the purchaser back to a search page or other page where a search feature may be again accessed.

Web page 552 also includes an information section 554. In this illustrative version, the purchaser is entitled to place up to ten horses on a single DVD. The web page 552 also includes “Remove” buttons 551 which allow the purchaser to remove a horse from selection for the DVD order.

Once the prospective purchaser has made his or her selection of horses for a DVD, the purchaser clicks the “Order” button 559. This ordering step is shown schematically in Box 550 of FIG. 2. This prompts the server operator to retrieve the video footage and, optionally, photographs and information, for the selected horses. The information, video and photographic files are retrieved from the database 150 and burned onto a DVD. The DVD is then sent to the prospective purchaser via U.S. mail or private mail courier for review.

Each DVD will have an index indicating clips and photographs for each respective horse. Contact information for the sellers may optionally be provided on the DVD. The DVD may optionally include a promotional feature from the server operator and also optionally paid advertising.

It is expected that the prospective purchaser will pay for the DVD service. FIG. 5K demonstrates a screenshot of page 555 allowing a prospective purchaser to fill out billing information for a DVD order.

The DVD is received by the prospective purchaser and viewed. Video footage of each horse is analyzed and the prospective purchaser then makes a decision as to whether to respond to the seller's offer. This may be a decision to purchase or lease or arrange for stud services for a selected horse. The decision step is demonstrated by Box 560 of FIG. 2.

As noted, the website 112 contains contact information 538 for the seller 120. Line 125 of FIG. 1 indicates communication between purchaser 130a and seller 120a. A prospective purchaser 130a may call, write or e-mail the prospective seller 120a in order to negotiate and consummate a transaction.

Referring once again to FIG. 2, and specifically again to step 500, this step makes the inquiry as to whether the user is or is not a purchaser. If the user elects not to act as a purchaser by searching for a horse, then he or she may nevertheless peruse the website 112. For instance, a user may contact the server operator in accordance with step 700. FIG. 7A presents a screenshot 702 with contact information for the server operator. This screen may be accessed by clicking the “Contact Us” link 305 referenced in FIG. 3A.

A user may also contact the server operator under step 700 as a prospective advertiser. Advertising information is provided on the website 112 through the “Services” button 311. FIG. 7B is a screenshot 702B showing more specific contact information for prospective advertisers.

A user may also choose to review advertising offered on the website 112. As noted above, one or more advertiser's links 304 may be provided on one or more pages, including the home page 302 of the website 112. The step of reviewing advertisements is presented at Box 380 of FIG. 2.

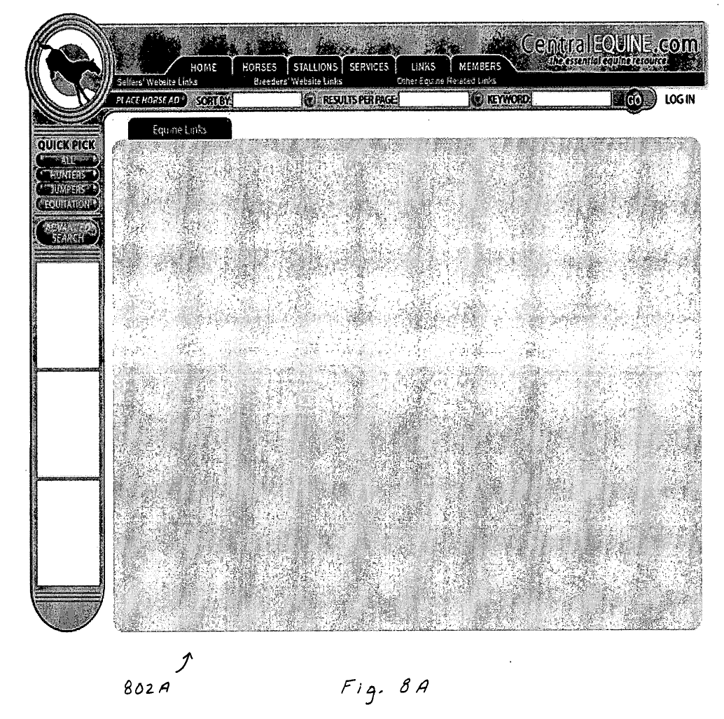

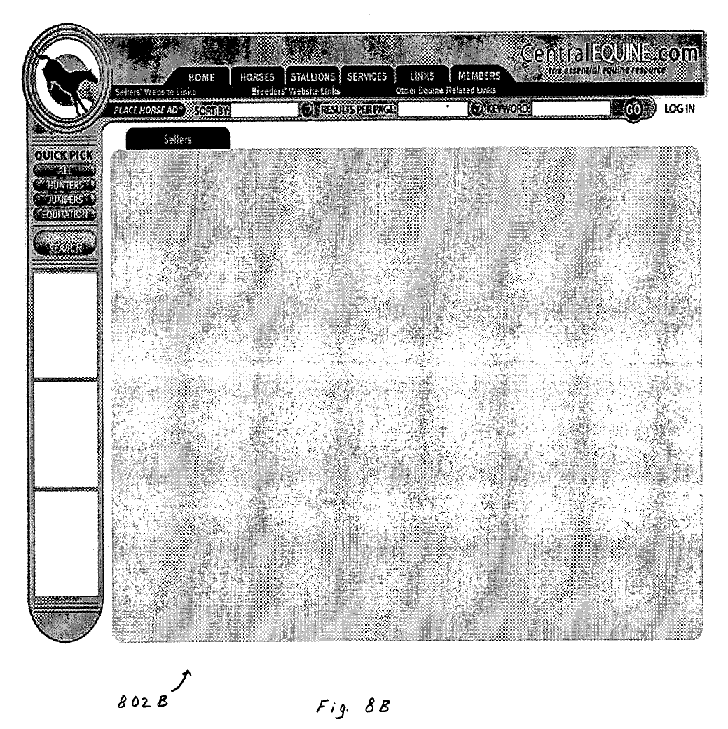

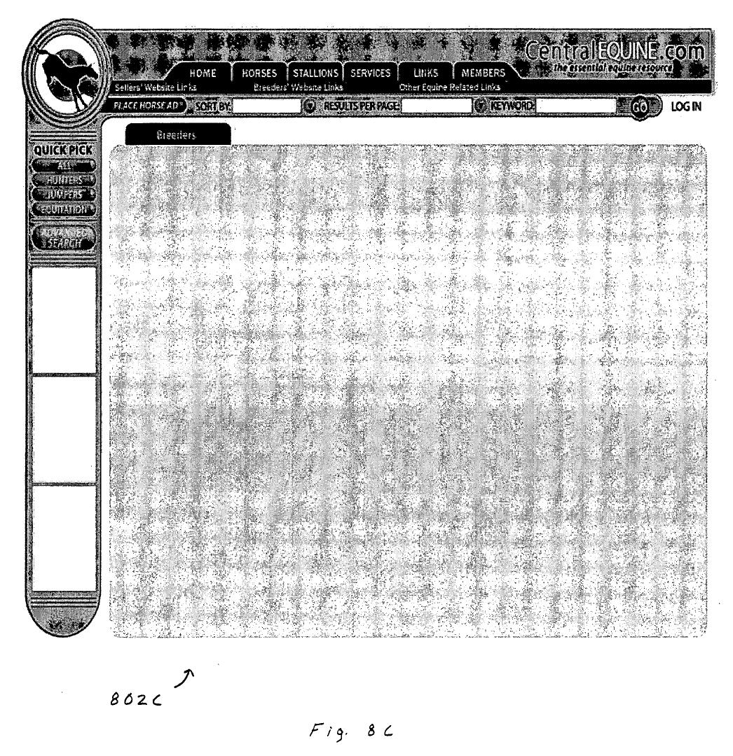

Finally, a user may choose to review links provided on the website 112. Various links pages may be accessed by hitting the links button 311. The step of reviewing links is presented at Box 800 of FIG. 2. FIG. 8A presents a screenshot 802A that would be used to list “Equine Links.” Similarly, FIG. 8B presents a screenshot 802B that would be used to list “Sellers” websites. Similarly still, FIG. 8C presents a screenshot 802C that would be used to list “Breeders website.” No particular websites are shown in FIGS. 8A, 8B or 8C, but it is understood that those may be provided.

As can be seen, a system 100 and method is provided that gives prospective purchasers greater information about horses without having to travel to actually see the horses. It also provides the benefit of allowing sellers to reach a larger pool of prospective purchasers through a computer network. Thus the system 100 facilitates a method for advertising horses.

The system 100 also facilitates the selling a horse. A prospective seller 120a enters the website 112 through the global data network 115. The seller 120a then enters profile data for a horse on the website 112. The information is received at the website and posted on the website 112 where it may then be viewed by remotely located prospective purchasers 130a, 130b . . . 130n. The seller also creates a video clip of the horse and then submits the video clip to the website operator.

In accordance with steps 510-540, a prospective purchaser searches the website, locates the seller's horse, and views textual and graphical information about the horse. In accordance with steps 550-560, the prospective purchase may also order a DVD for the horse, and then reviews the video clip on the DVD. The prospective purchaser then contacts the seller and a negotiation takes place for the sale of the selected horse.

I claim:

1. A method for facilitating the advertising of animals, comprising the steps of:
receiving textual information from a plurality of prospective sellers as to respective animals;
placing the information from the plurality of prospective sellers onto a database;
obtaining a video clip for each of the respective animals so as to establish a library of corresponding video clips;
making the textual information concerning the animals available for searching through a web-based platform;
receiving orders from prospective purchasers for video clips of one or more selected animals;
downloading at least a portion of the requested one or more video clips onto a digital video disc; and
delivering the digital video disc to the prospective purchaser.

2. The method of claim 1, wherein the animals are show animals.

3. The method of claim 2, wherein the animals are show horses.

4. The method of claim 1, further comprising the step of:
also placing at least a portion of the obtained video clips onto the data network for viewing on-line with the textual information.

5. The method of claim 1, wherein the step of receiving orders from prospective purchasers for video clips is done electronically through the web-based platform.

6. The method of claim 1, wherein the step of delivering the digital video disc comprises mailing the disc.

7. The method of claim 1, wherein the step of obtaining video clips comprises:
receiving analog video tapes from prospective sellers through the mail; and
converting the analog video tapes to digital files.

8. The method of claim 1, wherein the step of obtaining video clips comprises:
making digital video files of respective horses; and
loading the files to a database.

9. The method of claim 1, wherein the step of obtaining video clips comprises:
receiving electronically transmitted digital video files of respective horses; and
loading the files to the database.

10. The method of claim 1, further comprising the step of:
placing a promotional file for the business that receives the information from a plurality of prospective sellers onto the digital video disc before mailing.

11. The method of claim 1, further comprising the step of:
indexing the digital files for the respective horses on the digital video disc.

12. The method of claim 1, further comprising the step of:
placing a promotional file for an advertiser onto the digital video disc before mailing.

13. A system for facilitating the advertising of animals is provided, comprising:
a user interface for a server operator;
a network interface comprising a web browser and a data link;
a server defining a web-based platform having a processor, memory and software for enabling the server operator to communicate with a plurality of users through a global data network, the platform enabling the server operator to:
receive textual and photographic information from a plurality of remotely located prospective sellers as to respective animals;
place the information from the plurality of prospective sellers onto a data network;
make the data network available for searching through the web-based platform; and
receive orders from remotely located prospective purchasers for video clips of one or more selected animals, the video clips having been previously obtained from the plurality of prospective sellers.

14. The system of claim 13, wherein the animals are horses.

15. The system of claim 14, wherein the web-based platform is a website that:
permits prospective sellers to enter data about horses that are for sale so as to create listings; and
permits prospective sellers to search the horse listings, review data and graphics about the individual horses found through the search, and execute orders for DVD's containing video clips of selected horses.

16. The system of claim 15, wherein the website further permits prospective sellers to review photographs and portions of video clips for the selected horses.

17. A method for selling a horse, comprising the steps of:
entering a website through a global data network;
entering profile data for a horse on the website, the website receiving the information and posting it on the website for viewing by a remotely located prospective purchaser;
creating a video clip for the horse;
submitting the video clip of the horse to an operator of the website;
negotiating with a remotely located prospective purchaser for the sale of the horse, the prospective purchaser having viewed at least a portion of the video clip.

18. The method of claim 17, wherein the prospective purchaser viewed at least a portion of the video clip on the website.

19. The method of claim 17, wherein the prospective purchaser viewed the video clip on a DVD sent by the website operator.
